(19) United States
(12) Patent Application Publication
(10) Pub. No.: US 2018/0303135 A1
(43) Pub. Date: Oct. 25, 2018

(54) MATERIAL PROCESSING BY CONTROLLABLY GENERATED ACOUSTIC EFFECTS

(71) Applicant: Aqoya Technologies Ltd., Beit-Shemesh (IL)

(72) Inventor: Zamir TRIBELSKY, Beit-Shemesh (IL)

(21) Appl. No.: 15/768,041

(22) PCT Filed: Sep. 6, 2016
(86) PCT No.: PCT/IL2016/050982

§ 371 Date: Apr. 13, 2018

(30) Foreign Application Priority Data
Oct. 15, 2015 (IL) 242121

(51) Int. Cl. A23L 5/30; B01D 21/28

(52) U.S. Cl. CPC A23L 5/32; A23V 2002/00; B01D 21/283

(57) ABSTRACT

A method for processing a material, comprising propelling a bulk of material throughout an artificially generated storm, and rotationally impelling the bulk of material, thereby generating acoustic effects operative for processing of the material, where the acoustic effects comprise pressure gradients acoustically coupled to and resonating with the material with acoustic impedance matching, acoustic total internal reflections and acoustic absorbance adequate for different materials. The method is carried out by a duct-like vessel constructed for rotationally impelling a kinetically introduced material to generate the acoustic effects.

### BACKGROUND

Scientist, technologists, engineers and industrial entities with their many end users have been researching the art of forming vortex for many generations. The general physical principles and flow regimes of vortex have been established while the complexities involved in monitoring high power vortex remain unsolved due to the high rotation speed and transverse speed acceleration vectors often generated and the destructive forces which hinder the ability to provide real time sensing and analysis of such complex flow systems both hydrodynamically and aerodynamically.

Twister cyclonic separators are well known, as are vortex generators for reducing drag on aircraft wings. Vortex generators for crushing stones and drying applications are used with microwaves and alternative heating sources. On the whole, the engine driven vortex generators operate at low speeds such as several thousands (or tens of thousands) rounds per minute (RPMs).

Various apparatus and methods for generating vortices are known in the art. US Patent Application Publication Number 2001/0042802 to Youds describes a vortex for grinding and drying. Amplification of the vortex is achieved by introducing microwaves into the vortex machine. The vortex machine has a fan rotor and inlet fans. This method has moving parts inside (e.g., fans), its speed is limited to the turning speeds of fans. Microwaves are added to the process for purpose of drying applications and no supersonic speeds can be achieved.

U.S. Pat. No. 5,058,837 to Wheeler discloses vortex generators for flow control surfaces such as airfoils and hydrofoils on the wings of airplanes which can create vortices to transfer energy into a low energy boundary layer to delay flow separation without extending into the free-stream flow to cause excessive parasitic drag.

US Patent Application Publication Number 2014/0060959 to Regier et al. discloses a loudspeaker waveguide alignment with de-correlated sound utilizing continuum mechanics. Energy is harvested from one side of the transducers, re-energized, time aligned, and reintroduced to the signal from the other side of the transducer. The manipulated vortex waveguide loudspeaker alignment produces a multisource signal which combines and reaches equilibrium within the surrounding space at a distance from the loudspeaker.

US Patent Application Publication Number 2015/0090356 to Clingman et al. discloses a vortex generator for prevention of airfoil destruction on the wings of airplanes.

US 2015/0030439 to Pesteil et al. discloses a turbine engine for an aircraft comprising, from upstream to downstream in the direction of flow of the gases, a blower, one or more compressor stages, for example a low-pressure compressor and a high-pressure compressor, a combustion chamber, one or more turbine stages, for example a high-pressure turbine and a low-pressure turbine, and a gas exhaust nozzle.

US Patent Application Publication Number 2014/0328688 to Wilson et al. discloses a rotor blade assembly for wind turbine positioned on a suction side of the turbine at specific chord orientation.

US Patent Application Publication Number 2012/0180668 to Borissov et al. discloses separating liquid droplets from gas. The application discloses deep cooling of a gas flow, condensation of a vapor, and fast and effective removal of the condensed liquid with reduced pressure losses. These operations are performed by developing a strong swirling flow starting from its entrance, followed by spiral flow convergence in the inlet disc-like part, and then in a converging-diverging nozzle, by centrifugal removal of droplets, and removal of the liquid film through slits, then by spiral flow divergence and leaving the vortex chamber through tangential outlet. This method is primarily designated for separating droplets of water from gas, and the pressure this system requires may be in excess of 100 bars, thus requiring special safety precautions and a cumbersome system with little or no tuning ability.

US Patent Application Publication Number 2004/251211 to Suddath discloses a vortex creation apparatus in communication with a fluid system for treating a fluid, and a frequency generation device in engaged with the vortex creation apparatus such that a frequency is applied to the fluid near a chaos point of said fluid.

PCT Publication WO2006/067636 to Aspandiyarov et al. discloses treating and processing a hydrocarbon medium, by a cavitation reactor unit that includes an external wave radiator source, a hydrodynamic radiator, a vortex tube, and a flow accelerator. A high-speed turbulence, abrupt flow deceleration, and redirection of movement of the medium is combined with cavitation in the medium, effected by internal hydrodynamic phenomena and by the application of wave energy from an external source, to cause cracking in the medium without the application of external heat.

### SUMMARY

A method for processing materials by an artificial storm and all devices for use thereof, comprising spiraling simultaneously a volumetrically measured flow continuum or feed in motion, said feed is composed of at least one carrier and modulator propelled materials; catapulting coaxially at least one of said material simultaneously having quality and quantity parameters before or after delivering inter-spatially said feed through a vessel architecturally shaped acoustically with at least one functional utilization factor, or acoustic reflective layering, forming an artificial storm generator or in brief ASG in said vessel by said carrier and modulator flow continuum. Said artificial storm generator simultaneously effecting the compositional, structural or functional properties of said carrier or modulator therewith downstream by processing said carrier or modulator, or flow continuum or feed combinations by said storm at a predetermined intensity, duty cycle over a predetermine period of time.

The present disclosure generally relates to a method and all related devices for an artificial storm generator (ASG), and more specifically to a supersonic artificial storm generator for processing materials in the physical and/or compositional level.

### BRIEF DESCRIPTION OF THE DRAWINGS

Some non-limiting exemplary embodiments or features of the disclosed subject matter are illustrated in the following drawings.

Identical or duplicate or equivalent or similar structures, elements, or parts that appear in one or more drawings are generally labeled with the same reference numeral, and may not be repeatedly labeled and/or described.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

References to previously presented elements are implied without necessarily further citing the drawing or description in which they appear.

FIG. 1A schematically illustrates an ASG and basic components thereof, according to exemplary embodiments of the disclosed subject matter;

FIG. 1B schematically illustrates the ASG of FIG. 1A in a variant reduced form thereof, according to exemplary embodiments of the disclosed subject matter;

FIG. 2A illustrates a variable spiral in a side-view cross-section perpendicular to the central axis of the spiral, according to exemplary embodiments of the disclosed subject matter;

FIG. 2B illustrates the variable spiral of FIG. 1A in a view perpendicular to the central axis of the spiral, including some exemplary dimensions thereof (in mm), according to exemplary embodiments of the disclosed subject matter;

FIG. 2C illustrates the variable spiral of FIGS. 2A-B in a perspective view, according to exemplary embodiments of the disclosed subject matter;

FIG. 3A illustrates a constant spiral in a view perpendicular to the central axis of the spiral, according to exemplary embodiments of the disclosed subject matter;

FIG. 3B illustrates a spiral in a view perpendicular to the central axis of the spiral, including some exemplary dimensions thereof (in mm) that illustrate the constant pitch and indications of blades thereof, according to exemplary embodiments of the disclosed subject matter;

FIG. 4 illustrates an exploded panoramic view of an ASG apparatus for processing materials, according to exemplary embodiments of the disclosed subject matter;

FIG. 5 illustrates a section of the exploded panoramic view of an ASG apparatus for processing materials of FIG. 4, according to exemplary embodiments of the disclosed subject matter;

FIG. 6 illustrates another section of the exploded panoramic view of an ASG apparatus for processing materials of FIG. 4, according to exemplary embodiments of the disclosed subject matter.

FIG. 7 illustrates a schematic view of a material modulator being carried by a carrier and processed by an ASG apparatus according to exemplary embodiments of the disclosed subject matter.

FIG. 8 illustrates a schematic spectrogram view of a material modulator being carried by a carrier and processed by ASG apparatus according to exemplary embodiments of the disclosed subject matter.

FIG. 9 illustrates a schematic view of an ASG apparatus whereby the acoustic and kinetic effects are effective outside the ASG apparatus using the method of the present invention according to FIG. 1-8; and

FIG. 10 illustrates angular input of a carrier with respect to a longitudinal axis of an ASG apparatus according to embodiments of the present invention.

### DETAILED DESCRIPTION

Most development in the field of vortex creation and industrial processing engage high power moving parts, dangerous propelling blades, and high intensity engines of various types. These developments are strictly limited due to the limited speed and acceleration vectors possible to achieve using conventional electrically, mechanically, hydraulically or pneumatically operated engines. On the whole these systems may grind stones and attempt dealing with wastewater cyclonic separators but cannot feature the clean, accurate, tunable and extremely efficient processing according to the method of the present invention.

The use of engine driven moving part vortex poses strict limitations of speed, acceleration limits, processing efficiencies, energy consumption and most importantly safety. More specifically, these prior arts in the field maybe attempting to provide rough separation, sorting or grinding, and cannot effects materials in the physical or compositional levels with tunability. These prior art methods and devices are limited in exploiting the effects of sound waves for processing materials due to limitations imposing lack of coupling efficiencies and energy losses and lack of adequate reflections.

Furthermore, it is known that behavioral patterns of sound waves and acoustic vibrations obey the laws of reflections and since sound waves are waves, they obey the laws of refraction (Snell's Law) just like light. One can basically achieve total internal reflection of sound in any medium as long as it is transmitting into a faster medium above the critical angle for that boundary. For example, sound travels faster in hotter air. This means if sound was moving from cold air to hot air at a shallow angle to the boundary, one would have the total internal reflection of sound. Another advantage of the present invention as it can harness the effects of sound generated using total internal reflections. In the context of the present disclosure, an artificial storm generator described herein is also abbreviated and referred to as an ASG.

To harness the forces and energies, sonic resonating powers and acoustic wave generation of vortex remained shaded by the strict limitations effecting technical development in this unique field. These strict limitations stem from the lack of available means to monitor the high rotation speeds of vortex in the gas phase, analysis of nonlinear effects, acoustic analysis which cannot be achieved easily as the vortex destroy almost any sensor, microphone, detector, optical analytic tools, or pneumatic pressure detectors as well as many more analytical tools put in its path. Furthermore, to create a supersonic flute or a sonic industrial vortex processor was beyond the available prior art.

As a more specific example, the most used detection means to portray and analyze flow regime in today modern industrial processing is the use of ultrasound detectors. These cannot provide analytical signals for a vortex which passes the speed of sound in which these detectors work within its speed boundary (<MACH1).

In the context of the present disclosure, without limiting, processing a material in the physical and/or structural level implies controllably effecting or inducing effects on the material and/or constituencies thereof of one or more of the following: drying, sculpturing, shearing, tearing, texturing, sterilizing, dissociating, disintegration, coalescing, sorting, morphing, binding, crushing, particle size reduction, particle size increase, agglomeration, atomizing, fogging, acoustic-atomizing, powdering, extracting, homogenizing, separating, atomization, liquefaction, crushing, drying, physical interaction, temperature variation, and/or any combination thereof.

In the context of the present disclosure, without limiting, processing a material and/or constituencies thereof in the composition level implies controllably effecting on the material one or more of the following: reducing, concentrating, intensifying, reducing, diluting, mixing, cracking, dissociation, activation, recombination, chemical interactions, chemical reactions, and/or any combination thereof.

Some of the effects, such as atomization or dissociation, are of a borderline or overlapping nature between physically and/or structural and/or compositional effects.

The effects may occur in any plausible combination thereof, and at least some of the effects occur due to tearing and/or shearing and/or crushing and/or vibrating a bulk of the material.

In the context of the present disclosure, without limiting, a carrier is a fluid, such as a gas or liquid of adequate viscosity for flowing in a vessel, not precluding in a subsonic, sonic, supersonic or hypersonic speed.

In the context of the present disclosure, without limiting, a modulator implies a material flowingly carried with and/or propelled or be catapulted by a carrier. The modulator may be a substance and/or mixture of substances, or a material in various forms, textures, phases, granularities in a variety of particle sizes or aggregations in a variety of agglomerations. For example, the modulator may include material types such as food, beverages, oil products or plastic parts, agricultural, medical, industrial or domestic types of materials in any form such as amorphous, polymeric or crystalline substances and in any phase such as a fluidic or a thick viscous mass, a gel, a solution or a suspension form or phase.

In the context of the present disclosure, without limiting and unless otherwise specified, referring to processing or manipulating with respect to a material or modulator implies processing in the physical and/or structural and/or compositional level.

In the context of the present disclosure, without limiting, the term ‘acoustic coupling’ implies a degree or extent by which a substance is acoustically.

In the context of the present disclosure, without limiting, the term ‘acoustic impedance’ implies a measure related to the ratio of acoustic pressure to acoustic volume flow. The acoustic impedance is in generally frequency dependent and at a particular frequency indicates how much sound pressure is generated by a given air vibration at that frequency.

In the context of the present disclosure, without limiting, referring to suction implies spatially producing or inducing pressure difference or gradient and/or the effect thereof as a force applied on a fluidic substance or as a suction created by volume displacement such as Venturi suction.

In the context of the present disclosure, supersonic velocities or speed implies a rate of travel of an object that exceeds the speed of sound (Mach 1). For objects traveling in dry air of a temperature of 20° C. (68° F.) at sea level, this speed is approximately 343.2 m/s, 1,125 feet/s, 768 mph, 667 knots, or 1,235 km/h. Supersonic velocity in the context of artificial storm generation (ASG) technology described herein relates to actual fluid velocity (carrier velocities) relative to a body, or material composition or mass (modulator) in the fluid that is greater than the local velocity of sound in the fluid. It is important to note that the ASG is pumped with supersonic carrier gas or fluid, but velocities throughout the ASG reactor geometries may be sub-sonic, supersonic and hypersonic depending on the specific geometry stage, member or section transcend by the flow through of processed materials and their specifications as well as the intensities volumetric measures and operation parameters of the ASG system.

In the context of the present invention sound producing effects are those effects such as resonance formation, frequency shifts, sound wave production, standing waves, production of ultrasound waves, and mechanical vibrations as well as total internal reflections (TIR). Other sound effects include monophonic and polyphonic pitched sounds, non-pitched sounds to include effects which are produced as a result of high power flow of carrier (for example air or gas or fluid) and modulator (for example materials to be processed such as food and beverage compounds or constituents). It is relevant to note that in line with the speed of sound being about 4 times higher in liquids than in gas the critical angle for total internal reflections if the ASG vessel is furnished with layers along any portion of its inner walls—the critical angle for such total internal reflection is about 13 degrees.

In the context of the present disclosure, supersonic flow implies flow of a fluid over a body or object, particle or mixture at speeds greater than the speed of sound in the fluid, and in which the shock waves start at the surface of the body.

In the context of the present disclosure, flowingly implies the flow through specific geometries of gas, liquids, solids or combinations which steadily or continuously transverse or transcend the geometrical boundaries and come or appear at system end or distal section modified by the flow interactions. In an ASG apparatus it means the technical processing effects achieved between 1st inlet opening of the apparatus to its 2nd output opening or the consecutive opening after the introduction of material modulator to the propelling carrier. It is herewith acknowledged that sound waves are created with various parameters (pitch, frequencies, phase and harmonics to both high and low sound speeds).

In the context of the present disclosure, hypersonic means implies, as in aerodynamics, a hypersonic speed is one that is highly supersonic. Since the 1970s, the term has generally been assumed to refer to speeds of Mach 5 and above. This means 5 or greater times the speed of sound. In the ASG geometries hypersonic speeds develops in areas where pumping of driving fluid carrier such as air for example is substantially accelerated as well as in rapid transfer of mass modulator (materials to be processed) occurs and in operation parameters wherein the compression (narrowing down) of cross-sections effects the flow through of carrier fluid or gas and modulator as these transcend the downstream longitudinal axis of the ASG system prior to diffusion. Another technical aspect engaging far higher speeds than the speed of sound is the kinetic angular translation of the ASG. This means that a forward directional axis (such as that of the driving carrier fluid such as air) is translated into rotational speeds and then passed through a flow reducer causing extremely high transverse speeds far in access of the speed of sound. Example of such translation is the in motion of the variable pitch spirals effecting the inner flow within the ASG apparatus.

In the context of the present disclosure, sonic velocities imply the speed of sound, the speed of sound is the distance traveled per unit of time by a sound wave propagating through an elastic medium. In dry air at 20° C. (68° F.), the speed of sound is 343 meters per second (1,125 feet/s). This is 1,235 kilometers per hour (667 kn; 767 mph), or about a kilometer in three seconds or a mile in about five seconds since 5280 ft/1125 ft per second=4.693333 seconds at sea level., lowers than hypersonic and supersonic velocities. The speed of sound occurs within the ASG geometry prior to acceleration and post diffusion stages or where the carrier (gas or fluid) speed become quenched or diffused down at the diffusion stages, or where the modulator mass becomes too great for the carrier velocity and momentum forces to exert their accelerative effects. It is herewith acknowledged that sound waves are created with various parameters (pitch, frequencies, phase and harmonics to both high and low sound speeds).

In the context of the present disclosure, sub-sonic velocities imply velocities and speed lower than the speed of sound. In the ASG systems such speeds and velocities occurs at system output/outlets and at collection points along the system, or at the stage of materials to be processed prior to entering the ASG system and also in specific sections and passages throughout the downstream longitudinal axis of the ASG apparatus. It is herewith acknowledged that sound waves are created with various parameters (pitch, frequencies, phase and harmonics to both high and low sound speeds).

In the context of the present disclosure, ultra sonic spectrum range means the ultra sound spectrum define as frequencies above the 20 KHz in general (Human can hear from 20-20 KHz). 30 KHz can be perceive by certain rodents. At 70 KHz insects can perceive Ultra Sound. At greater than 150 KHz dolphins and bats can perceive ultra sound. At ASG geometry Ultra Sound is produced up to 220 MHz and assist in coupling acoustic energy to small droplets and particles as well as to molecular clusters prior to dissipating as heat to the surrounding apparatus inner walls, solids, fluid or gas boundaries.

In the context of the present disclosure, an audible/audio spectrum implies the range from 20 Hz to about 20 KHz. ASG technology platform generate a simultaneous (i.e. polyphonic) plurality of sonic pitches, frequencies and acoustic ripples and shock waves at this spectrum. The audio spectrum can easily be transferred efficiently in air and liquids, solids and suspended mixtures without causing damage or without passing above the damage thresholds of molecular structures. These audio ripples assist in increasing processing uniformities and in effecting larger molecules in the materials to be processed by ASG technology platform. It is important to note that ASG technology is limited in its capabilities to tune and control all pitches produced, but it can affect the resonance and fundamental pitch and subsequent harmonic production of affinity resonating pitches in specific sections and specific system parameters simply by adjusting the degree of opening and closing resonance cavities and augmenting and/diminishing the volumetric space which is effectively resonating at a given time or process eventuality.

In the context of the present disclosure, a frequency means the number of periods or regularly occurring events of any given kind in unit of time, most conveniently in one second, the number of cycles or completed alternations per unit time of a wave or oscillation. Symbol: F; In ASG processing context frequencies may mean the actual frequency of a specific acoustic wave or their respective pitch, the frequency at which a specific ASG processing sequence occurs or the frequencies of the resonating column (open or closed) within the ASG reactor architecture. The frequency of vibration resonance, harmonic generation and primary sound oscillation within the apparatus or sections of it. The frequencies of pressure gradient occurrences, and the interspatial time interaction of geometries and flow regimes within the apparatus.

In the context of the present disclosure, a waveform means a shape and form of a signal such as a wave moving in a physical medium or an abstract representation. Due to the high sheering and tearing force interplay within the ASG reactor geometries it is often preferred to monitor waveform from the outside using acoustic sensors or microphones as no conventional sensors will survive the turbulence flow format of the artificial storm generated within the ASG apparatus.

In the context of the present disclosure, a wave front means the plurality of points having the same phase: a line or curve in 2d, or a surface for a wave propagating in 3d. Many audio detectors are also phase-sensitive. It generally referrers to the spatial shape characteristics of a propagating wave and have some correlation to the specific effects such contoured waves may induce if harnessed at high energy densities and focus by acoustic reflective surfaces which are exactly what ASG geometrical architecture does among other functions.

In the context of the present disclosure, a resonance means the tendency of a system to oscillate with greater amplitude at some frequencies than at others. Frequencies at which the response amplitude is a relative maximum are known as the system's resonant frequencies, or resonance frequencies. At these frequencies, even small periodic driving forces can produce large amplitude oscillations, because the system stores vibrational energy. Different types of resonance can be achieved within the ASG apparatus using acoustic energy and the interactions of sonic, supersonic, hypersonic and sub-sonic fluid or gas carrier streams (driving feed streams) and the Thrust Vectoring Modulation (T.V.M.) induced by introducing into the system materials to be processed having mass, density, compactness and tactile, textural quality parameters as well as specific physical and chemical properties. The ability ASG devices to effect different vibration stages of materials passing through the apparatus.

In the context of the present disclosure, contrapuntal means, polyphonic, multi-pitched acoustic auditory lines or streams of acoustic waves of, relating to, or marked by counterpoint—con⋅tra⋅pun⋅tal⋅ly adverb Origin of CONTRAPUNTA Italian contrappunto (contrapuntal) counterpoint, from Latin contrapunctus. In the context of ASG technology this means the polyphonic (production of several acoustically tuned waves, shock waves and oscillating energy zones having variable pitch/frequencies produced simultaneously). This create a beneficial technical effects of phasing—It represents the unique capability of the ASG technology platform's geometry to produce several distinct pitched sound simultaneously with contrapuntal orientation which means that the frequency of 1 pitched sound rises or falls in counterpoint to another pitched sound which rises in its frequency or falls in the same system's geometry at the same time. This assist in creating uniformities in the acoustic high energy density zones inside the ASG. Contrapuntal also relates to the opposite directions in which these sound waves travel. For example, one sound wave travels downstream along the longitudinal axis of the ASG system, while simultaneously another acoustic waves at different frequency travel backwards along the same longitudinal axis. This greatly assists in the processing and spatial effects created by the ASG tech platform. The frequency range including harmonic generation of sound production by ASG technology span between <30 Hz to above the 220 MHz approximately. Contrapuntal technical effects also occur as a result of Thrust Vector Modulation induced by introducing materials having mass and density to be processed by the apparatus.

In the context of the present disclosure, compression means, the reduction in volume and increase of pressure of the air or mixture of carrier fluid/gas and modulator mass distribution proportions of materials processed in the processing column/reactor of the ASG. The pressure gradient of ASG technology are produced by the guided motion of the flow through toward the outer walls boundaries and along the varying diameter cross-sections of the longitudinally axis of the ASG processing geometry and impacting its varying geometrical utilization zones. It means that varying forces are excreted upon a surface or volume of processed materials by an object, fluid, etc., in contact with it. Various locations throughout the ASG geometry produce varying compression effects on processed materials. In ASG technology device architecture pressure gradients are common and may span order of magnitudes when correlated to initial pressure setting at launching of materials to be processed. This due to geometrical utilization factors of concentration members, reduction and increase in column (ASG reactor) diameters and variation in carrier fluid/gas at inlet as well as more localized micro jet streaming and implosion effects occurring due to flow interactions downstream on the longitudinal axis.

In the context of the present disclosure, concentration means the abundance of a constituent divided by the total volume of a mixture. Several types of mathematical description can be distinguished: mass concentration, molar concentration, number concentration, and volume concentration. The term concentration can be applied to any kind of chemical mixture, but most frequently it refers to solutes and solvents in solutions. The molar (amount) concentration has variants such as normal concentration and osmotic concentration. Concentration also refers to non-imaging optical concentrators such as the CPC (Compound Parabolic Concentrator). Concentrator also refers to acoustic concentrators in which the diameter, cross-section and path length effect acoustic waves traversing specified path length—increasing their energy density in specified geometries. In the context of ASG technology the concentrator/s have multiple functionalities by harnessing, collecting, concentrating and increasing flow through of fluids or gas, acoustic waves and aerodynamic and hydrodynamic flow reducing elementals such that the assimilative functionality of a concentrator is multiplicative. The term concentration also means the ability of the ASG apparatus to concentrate and focus intensities into specific zone, processing stage or section within the apparatus.

In the context of the present disclosure, acceleration means the rate at which the velocity of an object changes over time. An object's acceleration is the net result of any and all forces acting on the object, as described by Newton's Second Law and which applied to the ability of the ASG technology platform to accelerate the velocity and flow intensities of materials being mass and volume modulators, by the carrying fluid and gas carrier driving feed. Accelerations are vector quantities they have magnitude and direction and add according to the parallelogram law.

In the context of the present disclosure, deceleration means to decrease the velocity of moving objects, materials, and flow through objects. It means that the ASG technology platform accelerates and decelerates velocities prior to release of processed material modulators by the carrier driving feed. It also means slowing down rotational speeds and intensities such that adequate collection and transfer of processed materials is practically achieved safely.

In the context of the present disclosure, Carrier, Physical Velocity Carrier is the driving supersonic fluid or gas which carries along its path the materials to be processed by the combined interactions of the flow through of carrier and mass modulator individually collectively or cumulatively.

In the context of the present disclosure, Modulator Mass, Volume and density Modulator means effecting the thrust and flow regime, flow characteristics, and technical effects within the apparatus due to altered, modulated flow parameters (see Thrust Vectoring Modulation or in brief: TVM).

In the context of the present disclosure, velocity modulation means the modulation in velocity as in a cavity resonator, wherein passing the resonator transverse an electrical, or acoustical field. Velocity modulation may also refer to increase in speed and intensity of rotation within the ASG apparatus. Velocity may be modulated by TVM, by increase in flow rate, by increase in fluidic pumping pressure, and in alteration of amount or characteristics of geometrical utilization members or inserts within the apparatus.

In the context of the present disclosure, Thrust Vectoring Modulator (or in brief: T.V.M.) means, injecting into the ASG apparatus more than one fluid or gas or solids, or combinations simultaneously, sequentially, cyclically or non-recurrently or combinations thereof for purpose of modulating the thrust vectors within the supersonic Artificial Storm Generator (ASG) technology platform device architecture and geometrical utilization criteria. In simple layman terminology it means that the flow regime, format, or characteristics are modulated, or altered, by the introduction of secondary, or additional fluidic (or mixtures, suspensions, gels, solids or combinations) input which may comprise proportionate volume of materials to be processed by the ASG processing apparatus. Modulation also includes angular trajectories and injection angles or postures. The modulations and changes applied to the main flow characteristics are further accentuated by the special geometrical path characteristics such as for example the inclusions of spirals, concentrators, flow reducers, or flow expanders, or static stirring, or accelerative, or decelerator type system inner boundaries, cross-sections and shape gradients. This means that the introduction into the apparatus of materials having specified or known given mass, volume and densities, compactness and quality parameters changes the flow and modulate it by the following technical effects which are not limited to, but may include for example the following key parameters: Velocity increase/Decrease, Intensity parameters, rotational speeds, rotational sheer/tear, centrifugal/centripetal interactive tolerance range, retention time augmentations/Diminutions, Buoyancy effects of specific material constituents within mixtures, mixing homogeneities, and acoustic sound frequency modulations across a range from about less than 40 Hz to about over 80 MHz approximately, and wherein acoustic absorbance, impedance matching and volumetric coupling rates are altered due to the differing speed of sound in different mediums. The Thrust Vectoring Modulation (T.V.M.) also modulate the directionality and angular orientation in which acoustic energy propagate within the apparatus. For example, if heavy solids or dense liquids are introduced at the inlet, then the thrust is reduced or contoured down and hence the fluid and materials within the apparatus reduce their velocities hence the collective characteristic is less of a compressible medium which allow backwards-upstream (in contradistinction to downstream) for sound wave to propagate back to inlet. On the other hand, in contradistinction the volume and density are lowered or changed, then the supersonic acceleration does not allow backward propagation and the medium become non compressible which again change the way in which sound waves propagate through it. It is also quite beneficial if several of these modulated technical effect scenarios occurs simultaneously within the apparatus during processing as it maximizes the use of geometrical utilization members within the apparatus and enhances and fine tune the processing capabilities of the apparatus. Another example of beneficial technical effects of modulation is the ability to create and propagate various resonance frequencies and type such as for example vibration resonance and auto resonance of various sections throughout the apparatus downstream-path-length as well as the specie specific resonance of material's constituents passing through the system. It is herewith acknowledged that sound waves and acoustic resonance frequencies are created with various parameters (pitch, frequencies, phase and harmonics to both high and low sound speeds).

Buoyancy means, an upward force exerted by a fluid that opposes the weight of an immersed object. In a column of fluid, pressure increases with depth as a result of the weight of the overlying fluid. Thus a column of fluid, or an object submerged in the fluid, experiences greater pressure at the bottom of the column than at the top. This difference in pressure results in a net force that tends to accelerate an object upwards. The magnitude of that force is proportional to the difference in the pressure between the top and the bottom of the column, and (as explained by Archimedes' principle) is also equivalent to the weight of the fluid that would otherwise occupy the column, i.e. the displaced fluid. This can occur only in a reference frame which either has a gravitational field or is accelerating due to a force other than gravity. In the ASG apparatus this means that the effects of interactions of liquids, gases, solids and high velocities, thrust vectors and modulations effects of flow regimes—creates dynamic Buoyancy which accelerate mixing effects, create inner-impact of materials with their own counterpart nearby molecules and thus increase the processing efficiencies.

In the context of the present disclosure, tactile implies, perceptible by touch: tangible of, relating to, or being the sense of touch. It represents the ability of the ASG apparatus to textures or effect the touch aspect of materials and the contact processing attributes of the resonating geometry of the ASG apparatus.

In the context of the present disclosure, spatial means, relating to, occupying, or having the character of space. In ASG processing architecture it means that the mass, volume, shape aspect, and velocities and intensity of specific flow is shaped by the dimensional space of the geometrical utilization factor, or geometrical confinement factors applied to the flow. For example, the compression of a rotating spring type flow format such as for example is effected by a variable pitch spiral or a hollow truncated parabolic concentrator when the carrier fluid or gas and Thrust Velocity Modulator materials traverse the ASG apparatus from inlet to outlet during single pass.

In the context of the present disclosure, interspatial means, a space between two things; an interval or shape boundaries or confinements. In the context of ASG apparatus it represents the effect of boundary layers created by materials in motion and the space between various stages, walls, geometrical utilization members distributed along the longitudinal axis of the vessel which effect the flow through of materials to be processed. It also represents the intervals and distances within the apparatus for effecting the fundamental and subsequent harmonic acoustic sound waves while the flow through the vessel is in motion. Interspatial represent the utmost, most opulent feature and capability scope of the ASG technology platform which by the use and utilization of shapes (flow currents, particle shapes, flow regime shapes, pressure gradient expansion shapes, and acoustic wave-fronts propagation of shock waves impact on shapes of geometrical utilization members (such as narrowing of cross-sections, spiral angular orientations, concentration ratios and shapes, diffusive and deceleration flow expansion shapes) is what gives this unique technology its hybrid-multiplicative functionality of processing and the wide bandwidth of its beneficial processing advantages over conventional processing systems and means. It also represents the intervals of harmonically generated frequencies in relation to the fundamental frequency of the auto-resonance of the specific embodiment of the apparatus in a given processing environment.

In the context of the present disclosure, quantized means, to subdivide energy or timeline, or sequence of time lines into small, measurable increments. To calculate or express quantum mechanics, or kinetic energy into segments which can be measured to provide guidelines into setting apparatus operating parameters shown to have transformative processing effects by means of altering the aerodynamic properties and hydrodynamic geometrical utilization factors effecting the processing of materials by the ASG apparatus.

In the context of the present disclosure, without limiting, referring to atomization includes also supersonic atomization and formation of droplet sizes from about below 1 micron to above the range of 10-20 micron size, such as 50 microns.

In the context of the present disclosure coaxially means a set of circles having properties that each pair have same axis, also represent a set of cones or coiling sound sources having same axis or relating or referencing specified axis.

In the context of the present disclosure, without limiting, referring to acoustic matching implies matching the speed of sound in the gas carrier with that of the materials to be processed and also relating to the average sound speed within the apparatus at a given time or processing eventuality.

It is noted herewith that the acoustic effects of the generated storm within the ASG architecture acting as an acoustic impedance matching platform wherein the energy of sound waves is coupled to the carrier or modulator or combinations therein. The energy of the sound waves may also be coupled to the external perimeter of the ASG such as at its output whereby processed materials and carrier have already exit the system.

CIP means in the context of the invention abbreviation for Cleaning In Place. It further accentuates the inherent advantages of this application which due to the high velocities does not require CIP such as many industrial processing systems required. Especially beneficial for the fields of food and beverages, agricultural, medical, biomedical, and pharmaceutical to name but a few.

In the context of the present disclosure, referring to blades or winglets with respect to a spiral implies winding or curls of the spiral. It is noted that the blades of a spiral may have variable and/or contour and/or pitch.

In the context of the invention tunability means (tuning ability) that the Artificial Storm Generator is capable of being tuned. Such tunability is effectively applicable for both method and all devices for use thereof. The major advantage of the ASG method and devices for use thereof is the connectivity, interoperability and interconnectivity matrix of tunability as described (a-f). To the best of our knowledge, no other system ever developed feature such a tunability which is beneficial in processing wide variety of material on the compositional, physical a functional levels using the ASG of the method of the present invention.

In the context of the invention, Snell's law (also known as the Snell-Descartes law and the law of refraction) is a mathematical formula used to describe the relationship between the angles of incidence and refraction, when referring to light or other waves passing through a boundary between two different isotropic media, such as water, glass, or air. Snell's law states that the ratio of the sines of the angles of incidence and refraction is equivalent to the ratio of phase velocities in the two media, or equivalent to the reciprocal of the ratio of the indices of refraction:

$$\frac{sin {θ}_{1}}{sin {θ}_{2}} = \frac{{v}_{1}}{{v}_{2}} = \frac{{n}_{2}}{{n}_{1}}$$

In the context of the present invention TIR means Total Internal Reflections generated by the walls of the ASG vessel being furnished by a plurality of layers behind which air or gas maybe trapped such that some of the layers are transparent to acoustic waves and some are not. Thickness of these layer is, for example, about half of or quarter of the wavelength of sound.

As used herein, unless otherwise specified, the term ‘about’ with respect to a location or a position implies at or suitably close to the location or the position.

As used herein, unless otherwise specified, the term ‘about’ with respect to an axis or a pivot implies a round the axis or the pivot.

Unless otherwise specified, the terms ‘about’ with respect to a magnitude or a numerical value implies within an inclusive range of −10% to +10% of the respective magnitude or value.

The terms cited above denote also inflections and conjugates thereof.

One technical problem dealt by the disclosed subject matter is generating acoustic effects suitable for inducing processing of a bulk of a material.

Yet another technical solution according to the disclosed subject matter is providing a material inside a vessel into which a fluidic carrier is kinetically introduced.

The vessel is constructed for at least rotatively accelerate the carrier with the material and to produce in the vessel sufficiently high pressure gradients in motion and an acoustic resonance with a sufficient intensity and effective acoustic coupling to the material for achieving a required processing of the material. Optionally, the carrier with the material are further in motion axially accelerated within the vessel.

The vessel is generally formed as a duct analogous to an open or closed column with openings and/or inserts for tuning the acoustic resonance's standing waves to effectively match the material. The openings may be closed and opened in suitable combinations and/or the inserts may be moved inside the vessel to modify the columnar acoustic properties.

The material is carried along the vessel in a controlled speed that may vary between an insignificantly slow speed up to a supersonic or hyper sonic speed, taking into account the kinetic effect and thrust and shockwave on the material as well as the acoustic impedance and coupling stemming from the speed. Alternatively, a compounded flow maybe generated in motion wherein certain aspects of the flow are at various speeds in order to produce specific processing effects suitable for certain groups of materials.

The material may be provided into the vessel either as a continuous feed or by portions as a batch process or in other manners such as periodic continuous feeds.

A variant technical problem dealt by the disclosed subject matter is producing a rotating storm within a vessel sufficient for processing a provided material in the physical and/or the composition level, and that without independently moving parts while harnessing the acoustic, kinetic and dynamic flow properties of feed through materials passed through the ASG.

A variant technical solution according to the disclosed subject matter is producing an artificial rotating storm within a vessel at sufficient velocity for effecting or manipulating the composition and/or structural constituencies of a provided material. This is effectively useful for both processing materials inside the ASG, and also for processing materials outside the ASG on the launching output. Such examples of processing materials inside the ASG may encapsulate applications such as drying, homogenization, particle size reduction, mixing and texturing (to name but a few), while examples of processing material at the output of the ASG system may encapsulate application such as controlled atomization, contoured droplet formation, fogging, spraying particularly small clusters or clouds of droplets or streams, droplet size reduction and sheering, tearing, and droplet projection forward streaming effects. These are of particular benefit in drying applications and in reducing droplet size formation prior to further drying or processing materials post ASG processing. A carrier as a fluid flowing in supersonic or hypersonic speed is introduced into the vessel where a provided material, also referred to as a modulator, is driven or pumped into the flow of the carrier. The modulator is consequently processed due to interactions of the modulator with the structure and components of the vessel by an acoustic resonance generated in the vessel or via rapid pressure gradients, shock waves or standing waves or combinations.

The vessel is basically constructed as housing of a conduit having at least two hollow sections or chambers or cavities, and a length along a longitudinal axis from a first end or a front end in a downstream longitudinal direction to an open second end or rear end.

About the first end the vessel is formed with an at least one opening, leading or connected to a frontal hollow section, as a feed for the material modulator (to be processed by the artificially generated storm). Farther downstream from the first end the vessel is constructed with an at least one inlet obliquely downstream protruding from the vessel's wall into frontal hollow section the for supplying into the vessel a flow of fluid generally in supersonic or hypersonic speed, not precluding, in some embodiments, sonic or subsonic speed.

At the frontal hollow section downstream from the front end further from the feed and proximal to the protrusion of the at least one inlet is constructed a first spiral longitudinally opposite the first end and having blades of downstream varying increasing pitch.

The carrier flow may generate a suction that draws the modulator with and to the carrier into the vessel and impels the modulator onto the first spiral. Material modulators may also be forcefully injected into or pumped, or introduced at the inlet. Thus, once material modulator is introduced, the modulator is accelerated longitudinally and centrifugally towards the wall of the frontal hollow section and around the first spiral, thereby concentrating and at least partially processing the modulator with acoustic waves resonating in the frontal hollow section such as with standing acoustic waves or resonating open or closed column or combinations.

The rear end is formed as or with a hollow section having an increasing downstream longitudinally cross-section contour as an exhaust of the vessel, thereby the modulator is longitudinally decelerated and slowed down and diffused to a lower kinetic intensity for convenient collection of the processed modulator.

In some embodiments, in order to further process the modulator, a second spiral is constructed in a second hollow section downstream between the first spiral and the exit exhaust or gateways. Thus, the modulator is propelled or thrust, e.g. by the carrier, onto the second spiral that longitudinally and centrifugally further accelerates (or decelerates) the modulator flow in motion by at least one diverging geometrical member or intensifying concentrator or concentrated intensifying stage that concentrate the intensities of the modulator flow. In some embodiments, the second spiral is formed with a constant pitch or alternatively one spiral may have both constant and variable pitch along its longitudinal axis or cross-section.

In some embodiments the vessel is constructed with an at least one subsequent inlet to further provide carrier flow of fluid generally in sub-sonic, supersonic or hypersonic speed or combinations thereof, not precluding sonic or subsonic speed as part of the motion flow through the vessel by the carrier and material modulator. The at least one subsequent inlet is constructed to obliquely protrude downstream from the vessel's wall and directed towards the second spiral to provide further suction and/or thrust on the modulator towards the second spiral. Said subsequent inlet may be directed at any angular orientation in relation to the angular axis of the flowing carrier and modulator flow in motion throughout said vessel.

In some embodiments, yet to further process the modulator, another hollow section having a downstream decreasing longitudinal cross-section operating as a concentrator, or velocity intensifier (or a concentrating intensifier), also referred to as a first concentrator, is constructed between the first spiral and the second spiral. The modulator is farther propelled or thrust or catapulted longitudinally into the first concentrator and further sequentially accelerated and concentrated or having its velocities intensified.

In some embodiments the inner surface of the ASG processing vessel's walls is a rough surface, or the surface may include extension to protrude into the inner space of the vessel, in another embodiment the inner surface of the vessels walls are smoothed, polished or rounded to affect the material in motion flow interactions with said inner wall's surfaces.

In some embodiments, to still further process the modulator, yet another hollow section operable as a concentrator, also referred to as a second concentrator, is constructed downstream between the second spiral and the exhaust. Thus, the modulator is farther propelled or thrust intensified longitudinally into the second concentrator and further sequentially accelerated and its velocity thrust modulation intensified.

The conduit at least at the hollow sections or cavities thereof has predetermined shapes such as variable diameters that together with the structures constructed in the conduit exhibits acoustic resonance at least along the longitudinal axis thereof akin to a flute or an acoustic resonator. In some embodiments, the acoustic resonances may be controlled and/or modulated by one or more perforation and/or protrusions of various sizes and/or shapes, or by extension members or pipes extending out of the vessel—extending its dimension and volumetric inner space. Such extensions or protrusions may be constructed in the vessel and/or the conduit, or be attached to it, or be integral with its geometrical utilization (on board or externally added modularly). For example, the perforations, or extensions, or protruding members (protrusions) may be opened and closed at will and the shapes and depths of the protrusions may be changed at will within a specific range thus controlling the resonances, wavelength, frequency, standing waves, and vibrational intensities of the acoustic energy generated within the vessel.

In some embodiments further spirals and/or concentrators, or a concentrating intensifiers and/or inlets are constructed in the vessel in suitable positions therebetween or relative to other spirals and/or concentrators. In some embodiments these additional geometrical utilization members may take the form of inserts or modular interchangeable members or can be embedded in the geometry wall boundaries of the vessel itself.

The spirals and/or concentrators are designed and formed for suitably and/or sufficiently processing the provided modulator by accelerations and concentrations and acoustic resonances formed in the vessel due to the geometry thereof and/or components constructed therein. Thus, the spirals may have suitable fixed and/or variable pitches and the concentrators may have suitable contours either linear and/or curved contours. In some embodiments, a component in the vessel actually operates and/or functions as an acoustic reflector thus forming resonance such as standing acoustic waves.

In some embodiments, the exhaust is formed as a gradient acoustic horn with specific angular orientation so as to increase the coupling efficiencies of acoustic waves to the surrounding atmosphere, or for purpose of focusing the acoustic energy in a specific target sites. In some embodiments, the exhaust shape and/or orientation may be varied akin to the exhaust of a fighter jet engine.

Thus, the vessel and components thereof are designed and constructed in a manner that the sequential longitudinal and centrifugal accelerations produce sufficiently high velocities and swirling intensities that generate resonant standing acoustic waves and high pressure gradients within the vessel suitable for sheering and tearing interactions in the modulator with high vibrations adequate for inducing physical and/or compositional effects in the modulator, thus processing the modulator by cracking and disintegrating, or vice versa mixing or recombining the modulator to ingredients thereof or affecting the compositional states thereof and producing functionally multiplicative interactive yields.

Accordingly, a potential technical effect of the disclosed subject matter is an apparatus without moving parts capable of processing a provided material physically and compositionally.

A general non-limiting overview of practicing the present disclosure is presented below. The overview outlines exemplary practice of embodiments of the present disclosure, providing a constructive basis for variant and/or alternative and/or divergent embodiments. The exemplary embodiments do not intend to reduce the scope of the invention in aspects such as acoustic processing materials inside the ASG (1), or on output exit from the system (2) such as in the formation of small droplet fogging, small droplet clouds formation for example such effects and application platforms especially suitable for pre-drying applications.

The vessel is constructed for at least rotatively accelerate the carrier with the material and to produce in the vessel sufficiently high pressure gradients and an acoustic resonance with a sufficient intensity and effective acoustic coupling with the material to achieve a required processing of the material. Optionally, the carrier with the material are further axially accelerated in the vessel.

The vessel is generally formed as a duct analogous to an open or closed column with openings and/or inserts for tuning the acoustic resonance's standing waves to effectively match the material. The openings may be closed and opened in suitable combinations and/or the inserts may be moved inside the vessel to modify the columnar acoustic properties. The inner walls of the vessel maybe furnished with layers having sufficient thickness to allow total internal reflections (TIR) inside the vessel.

The material is carried along the vessel in a controlled speed that that may vary between a insignificantly slow speed up to a supersonic or hypersonic speed, taking into account the kinetic effect and thrust and shockwave on the material as well as the acoustic impedance and coupling stemming from the speed.

The material may be provided into the vessel either as a continuous feed or by portions as a batch process or in other manners such as periodic continuous feeds or a combination of feeding modes.

A variant technical problem dealt by the disclosed subject matter is producing a rotating storm within a vessel sufficient for processing a provided material in the structural and/or physical and/or the compositional level, and that without moving parts.

A variant technical solution according to the disclosed subject matter is producing a rotating storm within a vessel at sufficient velocity for effecting or manipulating the composition and/or structural constituencies of a provided material. A carrier as a fluid flowing in a suitable speed such as supersonic or hypersonic speed is introduced into the vessel where a provided material, also referred to as a modulator, is driven, pumped or introduced into the flow of the carrier creating a combined carrier and modulator flow in motion. The modulator is consequently processed due to interactions of the modulator with the structure and components of the vessel by an acoustic resonance generated in the vessel adequately for coupling of acoustic and mechanical energy and processing the modulator. The modulator is further being processed by the vibrational consequences of the flow in motion of said carrier and material modulator throughout the said vessel's geometrical utilization members (such as for example inserts, concentrating intensifiers, spirals, extension members, flow reducers, flow expanders).

The vessel is basically constructed as housing of a conduit having at least two hollow sections or chambers or cavities, and a length along a longitudinal axis from a first end or a front end in a downstream longitudinal direction to an open second end or rear end. The vessel may also be constructed with one longitudinal hollow section or stage.

About the first end the vessel is formed with an at least one opening, leading or connected to a frontal hollow section, as a feed for the modulator. Farther downstream from the first end the vessel is constructed with an at least one inlet obliquely downstream protruding from the vessel's wall into frontal hollow section the for supplying into the vessel a flow of fluid generally in supersonic or hypersonic speed, not precluding, in some embodiments, sonic or subsonic speed.

At the frontal hollow section downstream from the front end further from the feed and proximal to the protrusion of the at least one inlet is constructed a first spiral longitudinally opposite the first end and having blades of downstream varying increasing pitch.

The carrier flow generates a suction that draws the modulator with and to the carrier into the vessel and impels the modulator onto the first spiral. Thus, the modulator is accelerated longitudinally and centrifugally towards the wall of the frontal hollow section and around the first spiral, thereby concentrating and at least partially processing the modulator with acoustic waves resonating in the frontal hollow section such as with standing acoustic waves.

The rear end is formed as or with a hollow section having an increasing downstream longitudinally cross-section contour as an exhaust of the vessel, thereby the modulator (or the combined carrier and modulator flow in motion) is longitudinally decelerated and slowed down having its intensities diffused to a lower kinetic intensity for convenient collection of the processed modulator and discharge or reuse of the carrier.

In some embodiments, in order to further process the modulator, a second spiral is constructed in a second hollow section downstream between the first spiral and the exhaust. Thus, the modulator is propelled or thrust such as by the carrier onto the second spiral that longitudinally and centrifugally further accelerates and concentrates the modulator. In some embodiments, the second spiral is formed with a constant pitch.

In some embodiments the vessel is constructed with an at least one subsequent inlet to further provide carrier flow of fluid generally in supersonic or hypersonic speed, optionally not precluding sonic or subsonic speed. The at least one subsequent inlet is constructed to obliquely protrude downstream from the vessel's wall and directed towards the second spiral to provide further suction and/or thrust on the modulator towards the second spiral.

A potential advantage of the present invention is the higher efficiencies achieved using total internal reflections of sound waves within the ASG vessel. This is achieved by furnishing the vessel inner walls with additional layers having adequate refractive index. Example may include layers transparent to the sound waves, layers having rough surface curvatures or protrusions, and layers having thickness smaller than half or quarter of the wavelength of sound produced. Other layers, may be larger than the wavelength. The use of total internal reflections of sound waves increase the efficiencies of the harnessing acoustic energy for material processing on the compositional and structural levels.

In some embodiments, yet to further process the modulator, another hollow section having a downstream decreasing longitudinal cross-section operating as a concentrating intensifier, also referred to as a first concentrator, is constructed between the first spiral and the second spiral. The modulator is farther propelled or thrust longitudinally into the first concentrator and further sequentially accelerated and concentrated.

In some embodiments, to still further process the modulator, yet another hollow section operable as a concentrator, also referred to as a second concentrator, is constructed downstream between the second spiral and the exhaust. Thus, the modulator is farther propelled or thrust longitudinally into the second concentrator and further sequentially accelerated and concentrated.

The conduit at least at the hollow sections or cavities thereof has predetermined shapes such as variable diameters that together with the structures constructed in the conduit exhibits acoustic resonance at least along the longitudinal axis thereof akin to a flute. In some embodiments, the acoustic resonances may be controlled and/or modulated by one or more perforation and/or protrusions of various sizes and/or shapes constructed in the vessel and/or the conduit. For example, the perforations may be opened and closed at will and the shapes and depths of the protrusions may be changed at will thus controlling the resonances.

In some embodiments further spirals and/or concentrators and/or inlets are constructed in the vessel in suitable positions therebetween or relative to other spirals and/or concentrators. In some embodiments the vessel processing architecture is a symmetric shape, and other embodiments the vessel is having an asymmetric shape or structure.

The spirals and/or concentrators are designed and formed for suitably and/or sufficiently processing the provided modulator by accelerations, intensity concentrations and acoustic resonances forming in the vessel due to the geometry thereof and/or components constructed therein. The vessel maybe furnished with any number of modular inserts or geometrical utilization members. Thus, the spirals or geometrical utilization members may have suitable fixed and/or variable pitches and the concentrators may have suitable contours either linear and/or curved contours. In some embodiments, a component in the vessel actually operates and/or functions as an acoustic reflector or deflector thus forming resonance such as standing acoustic waves are formed in the vessel.

In some embodiments, the exhaust is formed as a gradient acoustic horn with specific angular orientation so as to increase the coupling efficiencies of acoustic waves to the surrounding ambient air atmosphere, or for purpose of focusing the acoustic energy in a specific target sites. In some embodiments, the exhaust shape and/or orientation may be varied akin to the exhaust of a fighter jet engine whereby processed materials are trajected at specific angles outwardly.

Thus, the vessel and components thereof are designed and constructed in a manner that the sequential longitudinal and centrifugal and centripetal accelerations produce sufficiently high velocities and swirling intensities that generate resonant standing acoustic waves and high pressure in motion flow gradients within the vessel suitable for sheering and tearing interactions in the modulator with high vibrations adequate for inducing physical and/or compositional effects in the modulator, thus processing the modulator by cracking and disintegrating the modulator to ingredients thereof or affecting the compositional states thereof and producing functionally multiplicative interactive yields.

Accordingly, a potential technical effect of the disclosed subject matter is an apparatus without moving parts capable of processing a provided material structurally and/or physically and/or compositionally. Another potential technical effect of the present invention is having an artificial storm generator producing acoustic effects within an acoustic waveguide wherein the inner walls of the waveguide are constructed of specific layers with gas or liquid trapped between the layers and the walls of the vessel.

A general non-limiting overview of practicing the present disclosure is presented below. The overview outlines exemplary practice of embodiments of the present disclosure, providing a constructive basis for variant and/or alternative and/or divergent embodiments.

Generally, a method for processing a material according to the disclosed subject matter comprises generating acoustic effects operative for inducing processing of a bulk of a material.

In some embodiments the method includes propelling and rotationally impelling and/or thrusting a bulk of material, thereby generating acoustic effects that comprise pressure gradients acoustically coupled to and resonating with standing waves with the material.

In some embodiments, the rotational impelling or the rotational impelling effect is provided or achieved by a mechanical element upon which the bulk of the material impinges. Optionally or alternatively, the rotational thrust is provided by driving the bulk of the material in an angle relative to the axial flow of the material. The angle may, optionally, be at least practically perpendicular to the axial flow and due to effects with the walls of the vessel a rotational flow may be induced, at least partially.

Optionally, in some embodiments, the method further comprises tuning the resonance for effective coupling with the material thus obtaining adequate acoustic impedance matching and acoustic absorbance for different materials. Optionally, in some embodiments, the method further comprises accelerating the material rotationally and/or axially for producing and/or enhancing and/or intensifying the acoustic effects. In some embodiments the acoustic effects include total internal reflections generated by the walls of the vessel having specific layers forming a refractive profiling index.

In some embodiments, the method includes the bulk material to be provided by portions such as in a batch process. In other embodiments the process includes a continuum flow in motion of carrier and material modulator or a plurality of carriers and material modulators. Optionally or alternatively, the bulk of material is provided continuously. Optionally or alternatively, the bulk of material is provided by train or succession of portions so that the method is performed by ‘pulses’ resembling a combination of batch and continuous process.

Generally, the method is carried out by a duct-like vessel constructed to rotationally impel a kinetically introduced material and further accelerating the material rotationally and/or axially. In some embodiments, the vessel is acoustically tunable to fit various materials. In some embodiments the material is kinetically introduced into the vessel by way of a fluidic carrier which by interacting with the vessel internal construction generates the acoustic effects.

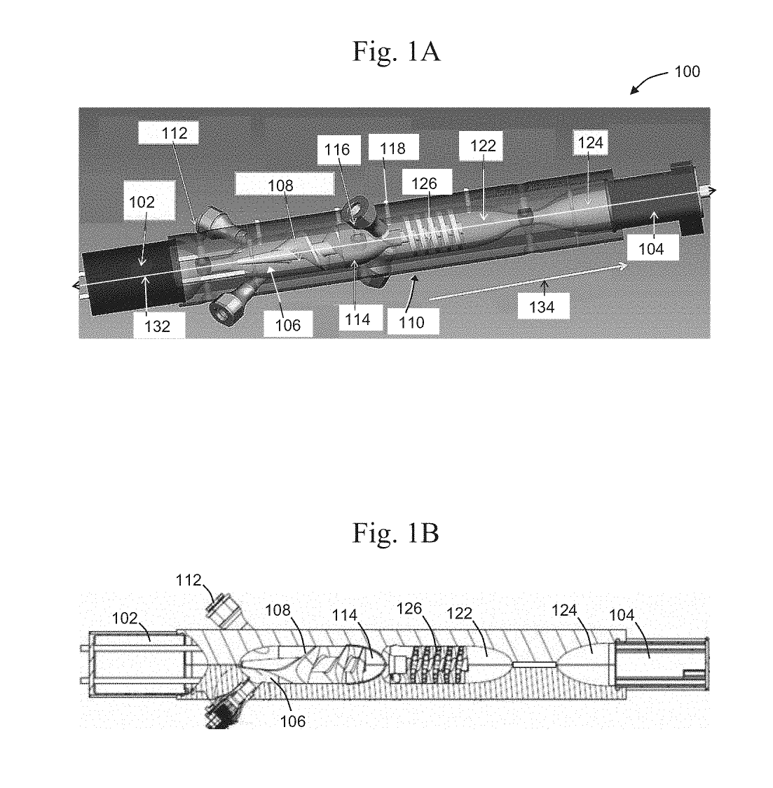

FIG. 1A schematically illustrates an ASG (100) and basic components thereof, according to exemplary embodiments of the disclosed subject matter.

ASG (100) is constructed as a vessel (110) housing therein a conduit having a length, as indicated by a double-arrow (132) that also virtually illustrates the central axis or core of the conduit and thus, effectively also representing the conduit. Generally, without limiting, the conduit is rotationally symmetrical about the central axis of the conduit, so that axes of spirals of ASG (100) described above and below are aligned therewith.

A material or a modulator flows in ASG (100) from an enclosure for holding or reserving the modulator, referred to also a reservoir (102), towards a structure or enclosure for accumulating or collecting the modulator, referred to also as collector (104). The direction from reservoir (102) towards collector (104), as indicated by an arrow (134), is also referred to as downstream or a downstream direction.

Downstream from reservoir (102) is constructed in vessel (110) a hollow section or a cavity (106), in which is constructed a first spiral (108) having blades with variable profile and pitch where the pitch increases along the downstream direction.

A first pair of an inlet (112) for providing a carrier fluid or a carrier in supersonic speed is constructed in the wall of ASG (100). The first pair of inlet (112) is obliquely directed towards first spiral (108) so that due to the suction effect of the carrier supersonic speed the modulator is sucked from reservoir (102) and driven into cavity (106) by volume displacement (Venturi). The modulator, together with the carrier, impinges on first spiral (108) which, due to the shape thereof, longitudinally downstream accelerates the modulator and further rotationally accelerates and propels the modulator towards the wall of cavity (106) and, thus, forcing the flow into a narrowing pass thereby inducing a compressing and concentration effect on the carrier and modulator stream. It is noted that the variable shape of first spiral (108) provides for increasing accelerations rather than an abrupt ones that, at least in some embodiments, may induce shock waves and/or other detrimental effects on and/or in ASG (100).

The accelerated modulator is downstream thrust or driven into a hollow section or a cavity having a downstream decreasing cross-section operative as a concentrator, also referred to as a first concentrator (114). Due to the decreasing cross-section of first concentrator (114), the modulator, together with the carrier, is downstream accelerated thereby the velocity and pressure are intensified, and forced out of first concentrator (114).

A second pair of an inlet (116) for further providing carrier fluid or carrier in supersonic speed is constructed in the wall of ASG (100). The second pair of inlet (116) is obliquely directed towards a second spiral (126) generally having blades of a constant profile and pitch. Due to the suction effect of the carrier impelling from the second pair of inlet (116) the modulator is further thrust and longitudinally and rotationally accelerated by second spiral (126).

The accelerated modulator is downstream thrust or driven into another hollow section or a cavity having a downstream decreasing cross-section operative as a concentrator or concentrating intensifier also referred to as a second concentrator (122), which is operative in a similar manner as first concentrator (114).

The modulator expelling out of second concentrator (122) is being thrust into a hollow section or a cavity having a downstream increasing cross-section also referred to as an exhaust (124). Due to the downstream increasing cross-section of exhaust (124) the modulator, together with the carrier, decelerates, expands, diffused and/or and dispersed at least to some extent.

Due to the remaining kinetic energy of the modulator and/or the carrier the modulator is propelled emerge into collector (104) and accumulates therein.

In some embodiments, perforations and/or through-holes, collectively referred to as holes, are constructed or fabricated in ASG (100). One or more holes may reach cavities and/or other parts of ASG (100) and may be used to tune physical properties or effects of ASG (100) such as effecting therein tuning resonances frequencies and/or velocity acceleration vectors and/or thrust velocity modulation and/or inter-spatial functionality and/or rotational speeds. Further, the one or more holes may be used to sample pressure and/or flows and/or substance therein, thus enabling to monitor and control the operation of ASG (100). An exemplary hole is illustrated as a hole (118). Likewise, in some embodiments, one or more inserts or protrusions (not shown), collectively referred to as inserts, are constructed or fabricated in ASG (100). The inserts positions and/or extents in ASG (100) affect the resonances frequencies and/or velocity acceleration vectors and/or thrust velocity modulation and/or inter-spatial functionality and/or rotational speeds, optionally in conjunction with the holes. The holes and/or inserts are designed and constructed according to the geometrical properties and components of ASG (100) in order to achieve sufficient or appropriate processing of the modulator.

It is noted that the tuning by the holes and/or insertions is performed manually and/or automatically, such as by actuators, optionally responsive to the operation of ASG (100) such as based on samples.

The structure of ASG (100) and the flow of the carriers and modulator therein are designed and constructed to produce or generate acoustic resonances to physically and compositionally process the modulator as described above. The geometries of ASG (100) and parts and components therein may vary based on the modulator and processing thereof, as well as of the carrier and speeds thereof.

It is noted that the carrier supplied in any of inlet (112) and inlet (116) may be of different nature, for example the carrier supplied in the pair of inlet (112) may be differ from the carrier supplied in the pair of inlet (116) such as by the respective fluids. Likewise, the speed in which the carrier from the pair of inlet (112) is supplied may differ from the speed in which the carrier from the pair of inlet (116) is supplied. For example, the carrier from the pair of inlet (112) is supplied in hypersonic speed and the carrier from the pair of inlet (116) is supplied in supersonic speed.

For clarity, it is further noted that reference to wall such as a wall of a cavity is an inherent property of the structure inseparable from the respective structure.

In some embodiments, ASG (100) may be modified or varied to include additional parts and/or operational phases. The additional parts may be designed and constructed to achieve an appropriate or sufficient processing of the modulator, such as in case the modulator is too viscous or ‘sticky’ to be processed without the additional parts.

For example, downstream of second concentrator (122) an additional third spiral may be constructed. Further, for example, an additional third concentrator may be constructed downstream from the third spiral.

In some embodiments, ASG (100) comprises fewer structures relative to the description above. For example, any one or any combination of first concentrator (114) and/or second spiral (126) and/or second concentrator (122) and/or pair of inlet (116) and/or any of hole (118) is absent. It is noted, however, that cavity (106), first spiral (108), exhaust (124) an at least one inlet (112) are mandatory for ASG (110) in the described reduced form thereof, possibly with reservoir (102) and/or collector (104).

In some embodiments reservoir (102) may be replaced by and/or augmented with one or more injectors that introduce the modulator into the steam of the carrier. Optionally, in some embodiments, the modulator is introduced into the carrier in the carrier inlets, such as into inlet (112). Optionally some other variations may be used, for example, introducing the carrier in opposite directions thus further compressing the modulator.

FIG. 1B schematically illustrates ASG (100) in a variant reduced form thereof, according to exemplary embodiments of the disclosed subject matter.

In the illustrated variant of ASG (100), second pair of an inlet (116) is absent and the carrier and modulator are propelled downstream due to the velocity of the carrier and acceleration by first concentrator (114). Also in the illustrated variant of FIG. 1B one or more of holes as hole (118) is absent.

It is emphasized that ASG (100) as described represents an example of a storm generator, where various components may be omitted and/or added and/or extended, possibly or, potentially at least, in a modular manner.

Thus, the storm generator operates on the basis of forming a Thrust Vector Modulation (TVM) by creating a supersonic vortex flow of a compressible carrier in a supersonic resonator, and modulating the thrust and intensities of the flow by the materials to be processed having a mass, and volume, densities and size distribution using a unique or distinctive interspatial modular matrix architecture.

Generally, the operation of the storm generator is based on at least one ‘geometrical utilization member’ which can functionally be a spiral, an intensifying concentrator, a flow reducer, a diffuser, a resonance tuning member and so forth, designed to propel the carrier and the modulator for processing the modulator. However, it is noted that certain aspects of geometrical utilization members, such as spirals, may be partially or wholly replaced by introducing the carrier at any angle relative to the longitudinal axis of the ASG vessel.

Further, the length, width, cross-sections and dimensions of the vessel and/or conduit and/or modular architecture of the device such as inlets and/or outlets and/or openings thereof, determine the type of waves, wavelengths and frequencies, which resonate and hence assist in the formation of acoustic wave ripples each having high energy density zones throughout the apparatus for processing a material which produce simultaneous processing effects by centrifugal and centripetal force interactions and Thrust Vector Modulation and further substantially and synergistically increase the efficiencies in which processing occurs

It believed that such material processing on the whole, and specifically for processing of food or beverage, is unique.

It is noted that, generally, ASG (100) in any variation thereof is operative without any independently moving parts therein.

Generally, spirals as exemplified above may be represented by parametric formulas (1)-(3) as below:

R(T)=R1+R2*T (1)

theta(T)=360*N*T (2)

Z(T)=N*P1*T+N*P2*T*T (3)

Where T is the radial angle, R1 the initial radius, R2 the final radius, N the number of turns, P1 the initial pitch, P2 the final pitch, theta the cumulative angle, and Z the shape of the spiral as a function of T.

Thus, when R2 and P2 are both 0, then the spiral curve is a general spiral helix curve, as, for example, second spiral (126); and when R1 and P1 are both 0 then the spiral curve is of a variable radius and pitch, as, for example, first spiral (108).

In the context of ASG (100) and further descriptions above, generally the spiral of varying radius and pitch, for instance, first spiral (108), determines and/or affects the flow of the carrier and the modulator more significantly relative to the effect of other parts of ASG (100).

The angular tolerance of each of the helical spiral blades or winglets is from about 14 degrees to about 160 degrees in correlation to the central core of the conduit or axis of a spiral.

For example, the final determination of angular orientation for variable pitch spiral depends on the processing effects required. Generally, it should be considered that from between about 38 degrees and higher the drag and downstream momentum losses such as reduction in energy or disruption of resonance induced by the forward surface impact are inhibitory or non-negligible. Therefore, at least in some embodiments, the tolerances suitable to achieve efficient preservation of downstream momentum acceleration and velocity are between about 10 to about 80 percent increase relative to the central axis of the spiral and/or the wall of cavity (106). Deviations from the cited tolerance range might, in some embodiments, cause detrimental diffusion effects at least outside of exhaust (124).

In various embodiments, ASG (100) may accommodate any variable pitch setting to assist a specific processing functionality. For example, a short 2 blades spiral may have pitch variability increase of about 33 to about 60 percent to achieve sufficient mixing and homogenization. On the other hand, for certain processing the aim is to disintegrate and generate separation effects and therefore in certain embodiments at least two additional blades would be required which might tolerate angular pitch increase between about 20 to about 50 percent with respect to the axis of central core of the conduit or axis of the spiral.

It is noted, however, that any of the described spiral may have any suitable shape, including that both spirals are of constant blades and/or pitch, and that both spirals are of variable blades and/or pitch. The same applies for possible spiral that may augment or extend ASG (100) or an equivalent and/or a similar apparatus. It is important to note that for specific material processing a single spiral may gave a designated variable pitch followed by any portion of set pitch or vice versa and wherein any of the spiral or combinations may have a variable diameter central core said core maybe hollow to allow access to the eye of the storm (e.g. to the central portion of the storm).

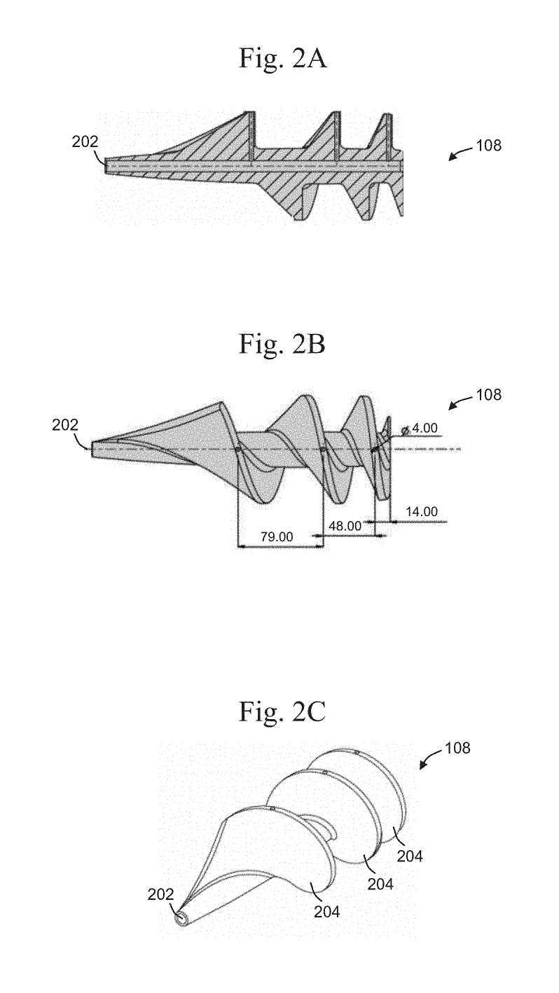

FIGS. 2A-2C illustrate views of a spiral of variable blades and pitch, such as first spiral 108 which is used as an example thereof, according to exemplary embodiments of the disclosed subject matter.

FIG. 2A illustrates first spiral (108) in a side-view cross-section perpendicular to the central axis of the spiral, denoted also as first spiral axis (202).

FIG. 2B illustrates first spiral (108) in a view perpendicular to the central axis of the spiral, including some exemplary dimensions thereof (in mm) that illustrate the variable pitch.

FIG. 2C illustrates first spiral (108) in a perspective view, including indications of blades thereof as instances of a variable blade (204).

In the context of ASG technology the variable pitch spiral means that the incoming supersonic fluid and/or fluids and the flow through of both the carrier and the modulators through the ASG geometry is effected by the varying pitched spiral.

In some embodiments, a spiral such as first spiral (108) is constructed with a hollow or a cavity therein and pathways that enable to introduce the carrier and/or material via the spiral. Optionally or alternatively, the hollow and pathways enable introduction of additives into the flow of the carrier and/or the material. Non-limiting examples of additives are flavors, emulsifiers, surfactant or any other ingredients such as enzymes.

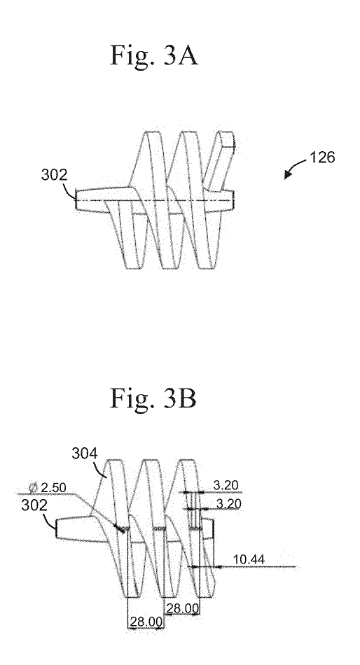

FIGS. 3A-3B illustrate views of a spiral constant blades and pitch, such as second spiral (126) which is used as an example thereof, according to exemplary embodiments of the disclosed subject matter.

FIG. 3A illustrates second spiral (126) in a view perpendicular to the central axis of the spiral, denoted as also as second axis (302).

FIG. 3B illustrates second spiral (126) in a view perpendicular to the central axis of the spiral, including some exemplary dimensions thereof (in millimeters) that illustrate the constant pitch and indications of blades thereof as instances of a constant blade (304).

In the following descriptions with respect to the figures the ASG is further described and elaborated.

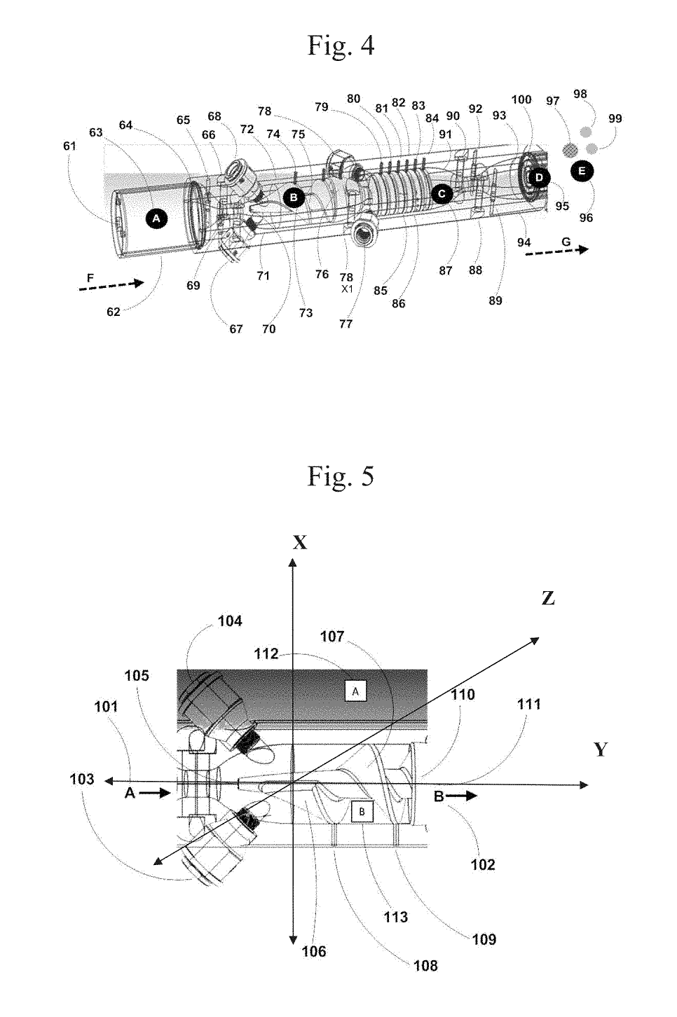

FIG. 4 illustrates an exploded panoramic view of an ASG apparatus for processing materials, according to exemplary embodiments of the disclosed subject matter.

An injection interface 61 wherein between (61), and through to (62), (63), (64) this processing section is represented by the block-capital letter (A). The processing section (A) include introduction of material thrust modulators into the ASG apparatus vessel, this section may have functions such as introduction of various materials, angular launching and may also serve as a premixing stage prior to impact of the materials with the supersonic carrier flow. Certain adjustment of this section may also effect a Venturi suction such that materials are being sucked into the vessel due to volume replacements effects created by the carrier fluid or gas. (65) and (66) illustrate an additional dual use input and outputs for purpose of controlling pressure gradient or levels and may open, close or partially open, manually, semi-automatically and automatically or in any combinations thereof for achieving the desired pressure gradients, curves or levels at the transfer stage from (A) to (B) which illustrates the gateway through which volumetric, sequential, cyclic, recurrent, or non-recurrently or in any combinations therein wherein the carrier fluid or gas are introduced at high intensities into the apparatus vessel at the desired flow rates within the limits of compressibility, safety and processing functionality required; (67), and (68) respectively are illustrated as the main supersonic inlet trajectory gateways into the vessel, both can be aligned or sequentially distributed in a range tolerance of about 180 degrees, or can be positioned to each counterblow the other, or staged in a contrapuntal orientation to impact against each other, or in combinations having variable or relative perspective to the central longitudinal axis of the vessel, more specifically, these fluid or gas carrier inputs marked (67), and (68) may include each individually, or in unison, or synchronously a single uniformly distributed flow current or stream, or may have each a compounded flow currents (made from a plurality of flow streams), both in terms of velocities, speed, intensities or spread portions, or can create a single compounded flow collectively, or in combinations, additional inputs can be added as needed to create the shape variability required for specific process; furthermore the carrier inlets may be offset angularly against one another to create turbulently programmable, or in contradistinction more laminar contoured downstream flow in the direction of the downstream-longitudinal-axis of the vessel represented by the letters and directional arrows (F), (G) at the bottom of the drawing; it is obvious to anyone skilled in the field without reducing from the scope of the invention, that the actual shape of each of the carrier inlet inputs may be same or differing in order to provide the spatial flow properties of this initial injection of carrier fluid or gas into the vessel; in a more general layman term's perspective this means that the carrier entry into the system can have specified shape (within limitations) while the ASG vessel further shape the flow spatially while simultaneously the materials (represented by 96-99-illustrated post system output) introduced into the system thrust modulate the velocities of the downstream flow through the apparatus; (70) illustrate the beginning of stage (B) which is the translational accelerative stage marked in reversed black capital letter (B) whereby this stage accelerate the materials to be processed and the carrier flows while simultaneously and interspatial translate their forward motion into rotational motion (70), (71), (72), (73), (74), (75), wherein (70) illustrates the starting tip of the spiral and (71) illustrate the encapsulating wall barrier of the vessel within which the variable pitch spiral (70-74) guide the interspatial flow (not shown) in the rotational axis of the spiral, (72) illustrate the diameter of the spiral at the translational accelerative stage, (73) illustrate the spiral central core, and (74) illustrate the input or output into the spiral in the shape of a pipe, conduit or an exit/entrance extension so materials, or carrier or combinations can be added (inserted), or subtracted taken out, or sampled, or such an input/output extension may be used for aroma extraction or insertion or for addition of additives, conditioners or additional constituents or combinations. (75) illustrate the winding winglet of the spiral in proximity to the wall encapsulation having variable pitch for interspatial guiding the flow throughout the vessel, (76) illustrate the entry into the concentrating intensifier, the variable pitch spiral is shown to enter the intensifier and partially be encapsulated by its narrowing-down walls or flow reducer geometry having a larger diameter entry and having a narrower diameter exit such as a parabolic profile with concentration ratios of approximately 3:1 in the downstream directional axis of the vessel, (77), (78) and (78 X1) illustrates additional inputs for carrier fluid or gas in order to preserve, augment or kinetically effect the interspatial flow processing through the vessel, (79), (80), (81), (82), (83), (84), illustrate a set pitch spiral inputs/outputs which provide additional extensive means to add or subtract from the interspatial flow of carrier and material thrust vector modulators (85), and (86) Illustrate the winding winglets of the set-pitch spiral, and (87) illustrate the entry into stage (C). This stage is a 2nd stage intensifying concentrator for further accelerating the rotational interspatial flow processing through the vessel, the narrowing walls geometry of the 2nd stage intensifier is illustrated as (91), shown in proximity are (88), (89) and (90) which illustrate geometrical supporting members enforcing the tensile strength of the vessel wall architecture to withstand the pressures and interspatial forces excreted outwardly by the inner flow, (92) illustrate an additional input/output which provide last additional or subtraction from the processed interspatial flow prior to entry into stage (D) which is one of the last diffusing stage whereby the speeds are decelerated, velocities are reduced and the speeds slowed down into safer, more manageable velocities prior to release or further processing, stage (D) is clearly shown having longitudinally a gradual diameter increase marked by (93), (94) illustrate the outer apparatus wall boundaries, and (95) illustrate the actual output from the vessel (and an exit part for processed material and carrier flow to exit the system), (96) illustrate a processed material example exiting the apparatus shown outside the system marked by the capital letter (E) appearing in reverse bold, (97) illustrate another material processed by the system having its quality parameters changed for example, said material have been reduced in size and being atomized into about 1 to about 50 Micron approximately marked in a grey circle with a mesh therein, (98) and (99) illustrate only two examples of carrier fluid or gas components being released out of the system or collected for re-compression or guidance into further processing stages, wherein (99) shown in a gray circle specifically illustrate an oxygen free gas or fluid, it is obvious to anyone skilled in the art without reducing from the scope of the invention that various types of gasses and fluids maybe used in this process, the oxygen free example represent one of many processing options, (100) illustrate a multi diameter output for collecting various aspects and constituents of the processed materials and carrier whereby the various diameters are adjusted to fit the centrifugal, or centripetal positioning of materials being thrust vectoring modulators at the exit stage of the vessels output (D), and (E).

Thus the ASG modular vessel apparatus architecture for material processing comprises an apparatus for processing material, comprising: A vessel having a length, diameter and at least one dimensionally varying cross-sections (A-E) along a longitudinal conduit (61-100), having at least one hollow chamber (A), (B), (C), (D), or gateway (69), (73), (B), (C), (76), (78), (91) flowingly produce at least one high intensity acoustic resonance or monophonic or polyphonic sound waves or combination produced interactively throughout 61-100 (A-G) having predetermined pressure gradients, frequency range, pitch or spectrum; said vessel is furnished with at least one inlet represented by (61), (68), (67), (77), (78), (79), (80), (81), (82), (83), (84), and outlet represented by (95) for accommodating in-motion flow through the vessel of predetermined volume of a supersonic driving carrier fluid or gas feed represented by (96), (97), (98), (99); said vessel is having at least one receptive member for tuning the sonic frequencies and pressure gradients within the vessel represented by (74), (79), (80), (81), (82), (83), (84) at least one geometrical utilization member or insert represented by (B), (C), (D), (72), (73), (74), (75), (76), is distributed sequentially between open first end represented as (61) to an open 2nd represented by (95), end through which materials are introduced represented by (A-E), (79), (80), (81), (82), (83), (84) to contrapuntally interact with and thrust vector modulate said carrier feed forming high intensity interspatial downstream combined flow represented by (96), (97), (98), (99), (F), (G), at between sub-sonic to hypersonic speeds and wherein at least one quantized quality or quantity aspect of said interspatial flow is equalized or tuned for achieving specie specific, or combinatorial processing effects throughout the vessel at specified volumes, flow rates over a predetermined period of time.

FIG. 5 illustrates a section of the exploded panoramic view of an ASG apparatus for processing materials of FIG. 4, according to exemplary embodiments of the disclosed subject matter.

Thus, according to FIG. 5 the vessel in the section thereof comprises at least one inlet for introducing materials into the processing track. The vessel inlet's initial input is indicated along line (101), in the direction marked A which represents the direction of the downstream flow to the vessel outlet's output (B). Carrier inlets (103) and (104) illustrate optional inlets, at least one carrier inlet is required to provide the thrust for the material thrust vector modulators (not shown). This schematic view is illustrated having two carrier fluid or gas inlets (103), (104) which are angularly positioned to contrapuntally coincide, or be aligned with the attack trajectory angle of the 1st geometrical utilization member being a relatively thin variable pitch spiral tip (105) positioned at the center of the vessel's cross-section represented by the X,Y,Z line axis indicator, where axis Y is aligned with the ASG's longitudinal axis. The spiral (105) in continuum is extending along the central core axis Y wherein its primary winding winglet (106 & 107) is shown twisting around the spiral core and appearing at its top in a variable angular winding posture having an extension member for sampling and subtraction, insertion and extraction member or pipe illustrated by (108). Sequentially downstream, at a different winding winglet of the spiral, an additional input/output extension member (109) is adjacent to, or in proximity to, the entry of a 1st stage concentrating intensifier (110). Concentrating intensifier (110) has an inlet diameter to outlet diameter concentration ratio of about 3:1, (111) illustrate the variable pitch spiral geometrical utilization member extending to reach inside the concentrating intensifier (110) such that the rotational flow is intensified (like compressing a spring). Area (112) represents the ambient atmospheric pressure, wherein within the ASG vessel apparatus area (113) has a pressure gradient in the range of about 1-99 bars. The pressure gradients are thus created inside the vessel by the geometrically interspatial manipulation of the downstream flow in motion having its thrust vectoring modulated by the materials being processed throughout the apparatus (not shown).

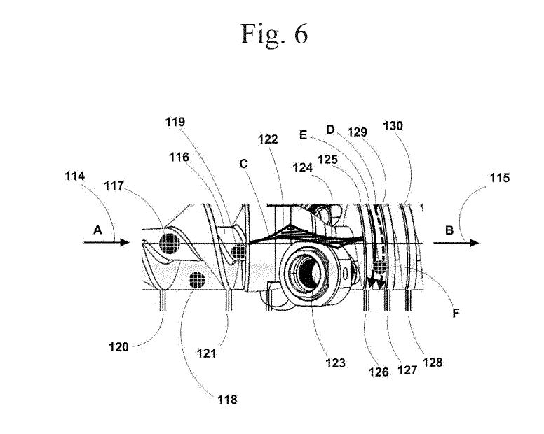

FIG. 6 illustrates another section of the exploded panoramic view of an ASG apparatus for processing materials of FIG. 4, according to exemplary embodiments of the disclosed subject matter.

Thus, according to FIG. 6 the vessel in the section thereof comprises the direction of flow through the vessel apparatus, illustrated by arrows (114), (115). The central core (116) of a geometrical utilization member may be, for example, a spiral, having a variable pitch. Material 117 illustrates a material in motion being subjected to translational guided motion by the spiral's pitch variability, (material 118) illustrates additional material acting as thrust vector modulator being rotationally positioned along the variable pitch spiral winding winglets forming an interspatial flowing processing element (114-130), (A-F).

Material (119) is an additional material having high intensity rotational velocities entering the concentrating intensifier (C). At least one optional sampling pipe insertion, subtraction, or extraction member may directly extend out of the variable pitch spiral winding winglet. Sequentially (to the right) such extension member (121) is shown. A distinct interspatial flowing shape (122) is shown extending to the right in the downstream flow direction (115). Inlets (123) and (124) illustrate at least one supersonic carrier fluid or gas inlet for propelling thrust and high kinetic energy throughout the vessel apparatus. In this schematic view two such inlets are included and are positioned contrapuntally to be aligned with the trajectory angular orientation of the central core axis of the vessel and the attack or guiding angles of the geometrical utilization members therein.

Spiral (125) is an additional set pitch spiral which further interspatial manipulate the flow of material thrust vectoring modulators therein whereby (D) illustrate the materials to be processed, (E) illustrates the streaming carrier fluid or gas and (F) illustrates the resulting processed materials having being affected by the interspatial flowing interactions within the vessel.

Special I/O (Inputs and Outputs) (126), (127), (128), reach inside the set pitch spiral and provide means to introduce or subtract extract and mix in additional materials, carrier fluids or gas, or any combinations thereof.

Winding winglets (129)) and (130) illustrate additional winding winglets of the set pitch spiral shown sequentially in the downstream flow direction of the vessel prior to reaching the diffusing stage (not shown) whereby intensities of the flowing interspatial flow are decelerated and processing intensities are reduced.

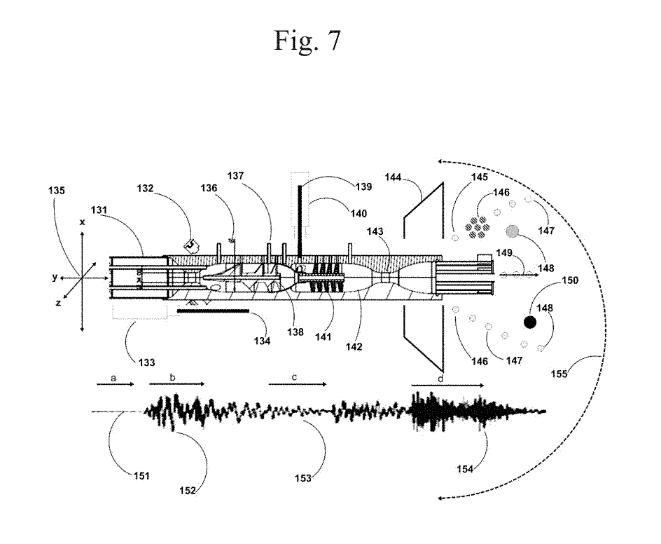

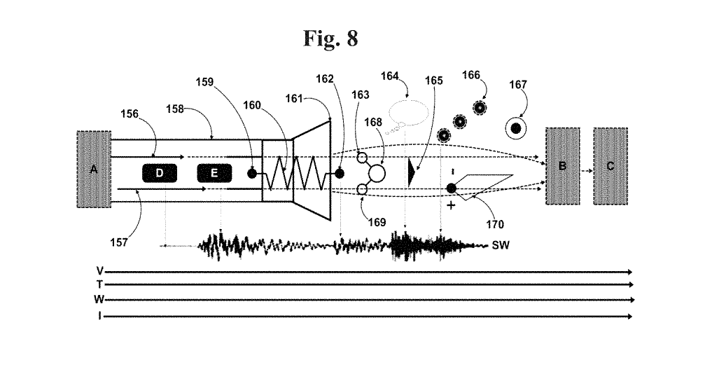

FIG. 7 illustrates an extended view of the three dimensions of the vessel and its multi-axis acoustic tuning ability and sound matrix.

Inlet (132) illustrates an inlet for the carrier while extension (133) represents an extension of the geometry of the vessel's volumetric measure, effecting the pitch of the sound waves and resonance generated by the storm. Extension member (134) may protrude into the vessel to reduce its length and available resonating space. Axes X, Y, Z of Axis (135) illustrates the directional axis of the flow of material modulator and carrier fluid or gas in motion, to illustrate that any possible directional axis such as rotation, angular diverging streaming is spatially possible. An additional insert member (136) may protrude from the vessel's geometry, e.g. from above like a piston on a musical open column resonating instrument or resonator.

An additional insert member (137)) may be used for adjusting the sound frequencies in the vessel. A variable pitch spiral insert member (138) may be used to effect the rotation speed and angular orientation of the flow in motion (of carrier & modulator combined). An extension member tip (139) may extend to protrude the vessel inner dimension from above, increasing its pitch by reducing its resonating volume. Housing and support means (140) are used for the protruding member's tip.

An insert member (141) may have a set pitch spiral, which act as an acoustic deflector, while ensuring adequate rotation speed to be maintained in the vessel during processing of the material. Concentrating intensifier (142) is a compound parabolic concentrating intensifier CPCI, which has a section or portion (143) of reduced diameter. The concentrating intensifier (142) is an insert member for further compressing and intensifying the rotational flow of carrier and modulator in the vessel for purpose of effecting the frequency of the resonating sound waves in the vessel.

Horn or expanding projecting shape (144) is provided for increasing the coupling efficiencies of acoustic sound wave energy to the outside ambient air just like a trumpet or a trombone acoustic horn. Single droplet (145) has already passed through the ASG and is being affected by the acoustic wave energy produced by the storm in the vessel. A cluster of small size droplets (146) represent a cluster of small size droplets of coffee, milk, or any suspension or liquid combinations being acoustically processed by the storm in the vessel (not shown) being atomized prior to drying, packing or further processing.

Material (147) illustrates one of three water vapor molecules being ejected from the atomized droplet cloud (not shown). Material (148) illustrates a single larger droplet being affected by the resonating acoustic energy produced by the storm in the vessel. Material (149) illustrates a stream of three drops of coffee, milk, or suspension, or any liquid combinations whereby the three droplets are connected by an arrow to illustrate that the acoustic energy have not yet taken effect. Material (150) illustrate a drop of coffee having size from 0.1 Micron to about 18 Micron approximately.

Graph (151) illustrates a spectrogram of the sound wave energy initiation in the vessel at the initial stage wherein the carrier fluid has just being introduced into the vessel (not yet accelerated) and acoustic energy is low. (Peak 152) represents a peak of acoustic energy after the carrier material modulator have been accelerated. Sound waves (153) illustrate high frequency sound waves being compressed by the geometry of the vessel. (154) indicates acoustic sound wave energy being produced outside the ASG vessel effecting the carrier and material modulator in motion producing atomized cloud of small droplets. Dispersion (155) represents the diverging angles of the atomized spread output of the ASG as function of the acoustic effects generated by the storm in the vessel.

At high pitch high rotation speeds the atomization will resume a spatial shape of an elliptical forward trajectory, while at lower rotational speeds and lower frequencies of sound the trajectory will diverge into wider angular orientation, larger droplet size and distribution as illustrated by the dotted line arrow.

FIG. 8 illustrates a schematic view of the ASG atomization output with pre/post coupling to ambient environment or additional processing units, according to embodiments of the present invention.

Graph SW represents a view of the sound-wave spectrogram evolving on the longitudinal axis of the inner dimension of the vessel transferring the vessel. Lines V, T, W and I underneath the sound wave graph SW represent the various aspects of the acoustic energy and sound waves generated by the artificial storm effecting processing of the materials inside the vessel, while (V) represents Velocity, (T) represents time, (W) represents wavelength and (I) represents intensity.

Various aspects such as a specific resonance, vibrational acceleration, frequencies (not shown) are all tunable aspects of the ASG which impact the processing quality and quantity aspects of material processed by the artificial storm generator (156-170). Three processing stages (A), (B), (C), are illustrated, wherein (A) illustrates the Artificial Storm Generator, while (B) and (C) illustrate additional processing stages to indicate that the ASG may have connectivity and interoperability with additional processing systems such as dryers, packing machines and/or mixers for example.

Insert member (D) illustrates an optional insert member such as a spiral. Intensifying concentrator (E) represents an intensifying concentrator for effecting the thrust velocity acceleration vectors. The carrier fluid or gas flow (156) illustrated is in motion, for example ambient air or CDA (Clean Dry Air) the carrier can also be any gas such as nitrogen or oxygen stripped air or a mixture of liquid gases and suspensions.

Material modulator (157) illustrates the material to be processed by ASG. Outer rim (158) illustrate the outer rim and outer surface of the vessel. Material modulator (159) illustrate the material modulator being effected by acoustic waves before exiting the ASG vessel. Sound waves (160) illustrate acoustic sound waves in the vessel reflecting by total internal reflections (not shown). Acoustic horn (161) illustrates an acoustic horn to assist coupling of the acoustic energy to the ambient air or gas outside the ASG vessel. Molecule (162) represents a material modular molecule which has exited the ASG vessel but is still being processed by the acoustic and kinetic energies generated by the artificial storm generator (ASG).

Droplets (163), (169), and (168) represent a larger droplet split into smaller droplets by the kinetic and acoustic energy of the ASG. (168) represent the larger droplet while (163) and (169) illustrate the smaller droplets atomized by the ASG after having passed through at least one section of the ASG prior to exit. (164) illustrates water vapor emerging out of the ASG or droplets or materials which have been processed by the ASG. (165) represent the diverging streaming flow (of processed materials) out of the ASG output effected by the mechanical, kinetic, acoustic, pressure gradients, resonance and acoustic standing waves generated by the artificial storm generated in the vessel and which may be subject to total internal reflections (TIR) due to adequate refractive index multi-layering or profiling of the inner walls of the vessel (not shown).

(166) illustrate 3 droplets (e.g., of coffee as an example) which diverge from the main streaming output having been processed by the ASG ready to be dried or processed further by additional processing or packing (not shown) and wherein their reduced size is from about 0.1 micron to about 18 Micron approximately. (167) illustrate a homogenized suspension droplet homogenized by the ASG comprising at least two constitutional F&B (Food & Beverage).

(168) illustrates a lager droplet or portion of processed material modulator which is split into two smaller droplets (or portions) represented by (163), and (169). (170) illustrates a droplet of processed material having a trajectory effected by the artificial storm generated in the vessel for which the angular orientation and diverging trajectory of said materials is subject to tunability (tuning ability) of the ASG.

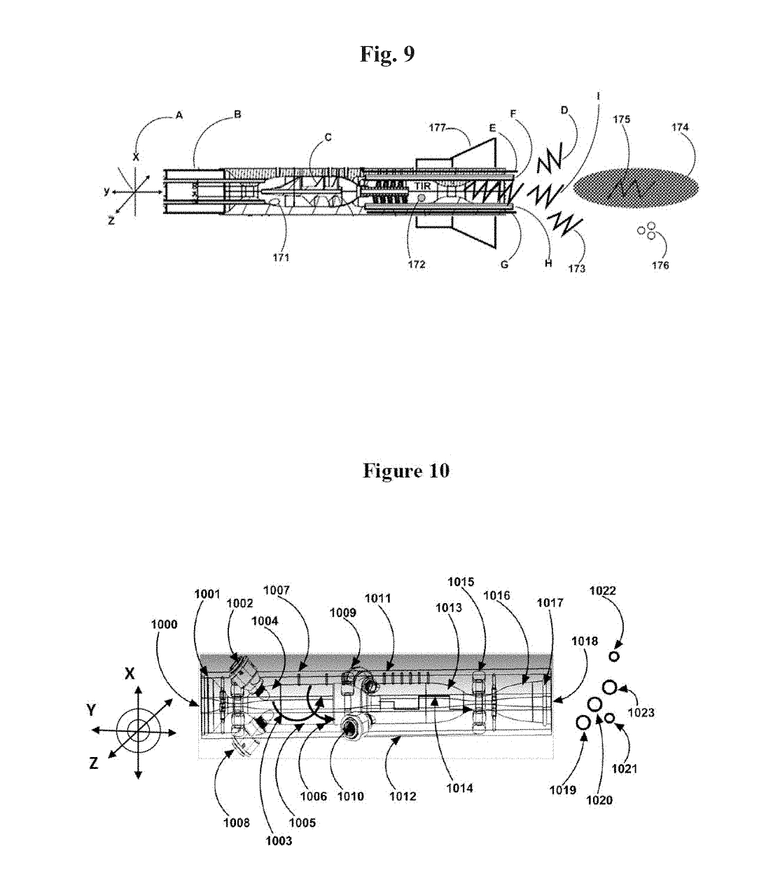

FIG. 9 (171-177, A-H), illustrates a schematic view of an artificial storm generator according to embodiments of the present invention.

(A) represents an X,Y,Z, axis to portray the angular rotation and divergence engaged in the rotating storm. (B) illustrates the reservoir of materials to be processed. (C) represents an optional variable pitch spiral, which in some embodiments is not required for generating the spiraling motion. For example, in some embodiments the material and/or carrier may be introduced angularly relative to the longitudinal axis of the ASG vessel, thus creating the spiraling motion. In yet other embodiments, a combination of angular material introduction as well as a geometrical utilization member may be used to generate the spiraling motion.

(D) represents a sound wave which have been generated in the vessel but is also effective outside the vessel (post outlet). (E) represents a first substrate layer near the walls of the vessel wherein between this layer and the walls of the vessel there may be air or gas purposefully trapped for generating a refractive profiling (acoustically) which is covered by one or more acoustically transparent additional layers having an appropriate thickness range, e.g. less than half or quarter of the acoustic wavelength to be reflected (not shown) in a grey thick line represented by (F). Both (E) and (F) collectively create a reflective layer which induces total internal reflections in the vessel illustrated in an angularly wavy black line (‘zigzag’) positioned underneath the grey layer.

(G) illustrates an additional first substrate layer near the walls of the vessel wherein between this layer and the walls of the vessel there may be air or gas purposefully trapped for generating a refractive profiling (acoustically). (H) is an additional acoustically transparent layer, which may be part of the reflective multilayer profiling on the adjacent vessel walls wherein sound waves are bounced from wall to wall in total internal reflections. Material 171 illustrates a bulk or portion of material prior to processing by the ASG before approaching the first spiral insert member. (Material 172) illustrates a bulk or portion of material which have been processed by the ASG, after passing through the vessel. (173) illustrates a sound wave which exits the system impacting materials which exit the system. (174) illustrates a cluster of droplets which has inside an acoustic ripple or sound wave represented by (175). (176) represents a cluster of water vapor molecules which exit the ASG vessel.

Reference is now made to FIG. 10, which illustrates a schematic expanded view of an ASG apparatus or vessel, with angular input of a carrier with respect to a longitudinal and cross sectional axis of the ASG vessel, according to embodiments of the present invention. It is noted that the method of connecting the inlets of the carrier to the ASG vessel, e.g. in an angular arrangement or disposition with respect to the longitudinal and cross sectional axis of the vessel, may cause generation of acoustic effects operative for processing of the material, e.g. instead of using a geometrical utilization member such as one or more spirals. Optionally, one or more carrier inlets (1000) may be included in the ASG. The ASG vessel may comprise a portion (1001) of narrowing diameter of the vessel for flow velocity acceleration. Another carrier inlet (1002) may be angularly coupled to the vessel body, such that when a carrier is introduced into the vessel, the carrier inlet (1002) creates or causes a rotating motion illustrated by arrows (1003) and (1006).

Optionally, one or more intensity concentrators or flow reducers (1004) may be included in the ASG vessel. Pistons (1007), (1011) illustrate pistons or inserted screws for adjusting acoustic parameters, such as open or closed resonance, frequencies and intensity of standing waves in the vessel. Acoustic waveform (1014) is illustrated as a rectangular acoustic waveform induced by interaction between carrier and modulator in the vessel (1005). Particles (1019-1023) represent particles of various sizes, including a reduced size particle (1021), and water vapor (1022) departing upward. Inlets (1009) and (1010) are additional optional inlets for carrier or modulator, which may be orientated in various angles in relation to the longitudinal and cross sectional axis of the ASG vessel. To the left of the illustrated schematic view of the ASG apparatus an X, Y, Z axis for angular orientation indication is herewith included, illustrating a round circle of 360 degrees and arrows (X,Y,Z axis), portraying that angular coupling of carrier and/or modulator or combinations thereof into the ASG vessel may be performed at any angle from axial to perpendicular, or in any combinations thereof for inducing a rotational, turbulent, vortexian, laminar or combination flow regime in the ASG vessel, without the use of any spiral or static stirring element within the vessel.

The acoustic impedance matching effect the inter-spatial processing ability by increasing geometrical utilization to achieve the desired specific functional ASG processing. The faster and more intense ASG processing-the higher matching efficiencies achieved. This is due to the higher speed of sound waves in a compressed more dense matter, especially when sub-sonic and supersonic speeds are within reach or being approached.

The operation of the ASG, such as ASG (100) and/or variation thereof, changes the acoustic impedance as function of acceleration and velocities and pressure gradients. The pressure gradients change the coupling efficiencies of sound waves, shock wave propagation efficiencies, standing waves, resonance formation speeds and self-amplification effects as is the fundamental principle of resonance formation within the ASG architecture, these effects can also be seen in increasing sound absorption in the material to be processed (by ASG) and their respective color temperature of absorbing acoustic energy on the whole and overall applied acoustic energy intensities throughout upstream and downstream paths lengths.

The acoustic impedance effects the applied speed of sound in the modulator to be processed. In this perspective, the ASG conceptualizes and provides for one acoustic impedance matching platform in the form of a storm generator/synthesizer. Accordingly, the higher the speed of propelling inside the ASG, including transverse speed, rotational speeds, acceleration and resulting pressure zones formation, the faster the speed of sound propagating in the materials- and hence the higher subsequent coupling efficiencies of sound waves throughout the ASG and also at its distal tip (i.e. at the output of the system where the processed materials are being launched or exit the ASG system).

Furthermore, it not only the higher speed of sound that matter, but, rather, also the considerable higher energy density of acoustic energy per surface unit or per volume unit of combined carrier and modulator/s in motion in the context of shock wave formation, resulting, potentially at least, in processing consequences and functional processing capability. For example, at certain rotation speed of 1000 RPM (Rounds per minute) the energy density may reach several Watts per centimeter² of surface area or several Watts per centimeter³ of modulator material volume, but at a 100,000 RPM the energy density may reach a range of hundreds of Watts where sufficient retention time is enabled.

It is noted that the speed of sound in air is by far lower than the speed of sound in liquids and solids. Thus, at sub-sonic speeds just below supersonic speeds and higher the compressible factors of air change to become much less compressible than air or similar gases and behave like solid matter. Consequently, the speed of sound of the combined carrier and material TVMs inter-spatially flowing throughout the ASG vessel increases. Correspondingly, the higher the speed and acceleration the higher the coupling coefficients.

The acoustic impedance effects represent prominent and unique two-fold advantage or benefit, as demonstrated below for low speed and high speed modes.

At high speed, which is characterized by suitably good or appropriate acoustic impedance matching between the gas carrier and material trust vector modulators, the effect will be manifested by forming variable textures by effecting particle size and distribution (PSD), homogenizing, crushing and texturizing.

Thus, as the impedance matching is suitably good, the acoustic energy propagate at much higher energy densities and intensities for much longer distances and resonates with resonances much longer standing waves and utilizes the acoustic properties of the ASG geometry in comparison to significantly lower speed and lower energy hence produced.

Accordingly, at high speed with ensuing higher acoustic coupling and matched impedance conditions the acoustic energy would propagate both downstream and upstream contrapuntally, resulting in cross fading effect that increases the overall processing functionality of the ASG while substantially increasing the uniformity of processing throughout the ASG eliminating head loss (locations in the ASG geometries where energy is low compared with other areas or segments).

Acoustic Impedance Matching (in abbreviation AIM) also effect that atomization characteristics, range and spatial properties and intensities by having the acoustic energy coupled into the surrounding air (outside or inside ASG architecture) for effecting the acoustic atomization effects of ASG according to the present invention.

At low speed that is characterized by insufficient or deficient impedance matching, the effect, at least possibly, possibly inclines towards mixing, smoothing, frothing and more roughly bubbling formation with the gas carrier. Consequently, at low speed that generally reaches up to sub-sonic speeds where the impedance matching is deficient, a significant portion of the absorbed sound is converted to heat which is cooled by the passing gas carrier and material thrust modulators, thereby inducing remarkably rapid heating and cooling of molecules within a narrow range.

In the context of the invention, coiling means to form rings, spirals, etc.; gather or retract in a circular way.

Catapulting means in the context of the invention, to thrust or move a material or a carrier quickly or suddenly in a rapid accelerated action, or a continuum of such action/s. It is these actions and processing curves which change and alter the processing types and qualities of the artificial storm generator according to the present invention.

Acoustic total internal reflections (abbreviated TIR) means in the context of the present invention total internal reflections of acoustic waves by a liquid or fluid or solid air or combination interface which by introducing a refractive index profiling having adequate thickness along the vessels inner walls or surfaces wherein a portion of it is transparent to the wavelength and portion of it are in different phase (such as liquid, gas, solid interface) said interface is designated for inducing partial or total internal reflection of said acoustic waves, this may be implemented in the ASG vessel by having a plurality of layers along at least one portion of the vessel inner walls such that acoustic wave propagation is enhanced by TIR created by the artificial storm generated.

In order to clearly define such tunability the following exemplary modes of operation and modes of utilization are herewith included for clarity without limiting the scope of the invention. The ASG can be tuned in both real time and step time either in consecutive steps or in continuum variability.

Such tunability can be applied to the following key method and device aspects.

(a) dimensions of the inner volumetric measure of the ASG which directly impact the acoustic resonance and wavelength and frequency of the resulting acoustic wave propagation and characteristics whenever the ASG is operated.

(b) tunability of the modulation and Thrust Velocity Modulations (Abbreviated TVMs) which means the rate at which a predetermined mass, volume, weight, viscosities and momentum of material quantity and quality is added to the system to coincide with specified acceleration or flow rate or speed of processing within the ASG.

(c) tunability which impacts acceleration and/or deceleration of any chosen carrier or modulator within the ASG. This type of tunability effects geometrical utilization and can be seen for example in a range of concentration ratios for the CPCI (abbreviated for Compound Parabolic Concentration Intensifier) examples which include tuning or changing the concentration ratios of CPCIs in the system from 2:1 to about 8:1. This type of tunability effects the geometry and increase or decrease the diameter, path length and subsequent intensities achieved within the ASG processing architecture.

(d) tunability of pitch and frequencies of the ASG which is a type of tunability that is similar to tuning a musical instrument, such as trombone for example, whereby the pitch is changing as a result of elongating the open or closed resonating column. Such tunability may be performed in steps or in a continuum telescopic manner or in combinations thereof.

(e) interspatial tunability that is a of tunability that may affect the geometrical shape and characteristics of the flow regime of both the carrier and modulator within the ASG and can be achieved using both variable pitch spirals or set pitch spirals, hollow inserts, winglets, holes, slits, opening, closing and by extending the length or shortening the length of the ASG on the whole or for certain processing segments or stages specifically.

(f) tunability of duty cycles and throughput rates by enlarging the output diameters, or reducing the diameter either by using iris or by a mechanical flange types for purpose of creating chock flow regime types or for allowing increase or decrease in flow of carrier or material modulator through the ASG device architecture.

(g) tunability of trajectory angles for atomization or for carrier and/or processed materials at the ASG output. Such a tunability may be effectively applied by tuning other tunability aspects (a-f) such that certain resonance and shock waves, frequencies and wavelength of acoustic sound are generated, and a certain accelerated vectors achieved for specific processing. For example, creating a fogging cloud or a specific droplet distribution prior to drying material processed by ASG into powder or for concentration purposes.

(h) tunability may also include rotation speed such as from about below the 1000 RPMs to above 2 Million RPMs. This type of tunability is effectively applied by altering the angular orientation of carrier inlet trajectory, or by adjusting the spiral pitch, or number of folding winglets, or by adjusting the distance between any inserts in the ASG system and the next CPCI or by placing a sequence of spirals and inserts in specified distances from one another or in a continuum sequence. Such effective distance may be extended from several millimeters to over 100 centimeters. It is obvious that tunability may also be applied to flow rate, flow speed and ASG device throughput by tuning any of the tunability aspects (a-h).

The tunability of the ASG is interactive which means that any tunable aspects can coincide, be designated, controlled by, or be altered using other aspects of tunability. For example, if we tune the resonance of the ASG to about 3000 Hz approximately, and set the concentration ratios of the CPCI to about 3:1 respectively, and we close all of the resonance tuning holes we can achieve substantial sub-micron size particle size reduction and subsequent atomization at system output with an elliptical spatial distribution and a trajectory angular orientation of about 10-30 degrees approximately, but once we open any of the resonance holes we can enlarge the size by an order of magnitude, thus a tunability can be achieved by adjusting one or more of the tunable aspect of the ASG.

Another example of tunability may be seen by driving the ASG with subsonic carrier velocities and accelerating the carrier and material modulator to supersonic velocities within the system by adjusting the path-length, diameters and spiral pitch in any of the inserts (such as spirals) or by changing the insert CPCIs concentration ratios. Alternatively driving the ASG with supersonic speed and velocities from an external blower, compressors, compressed air or gas system prior to the carrier entering the ASG allow acceleration to sub-hypersonic or reduction to sub-sonic velocities using any of the tunability aspects (see a-h).

Another example of applicable tunability may include particle size reduction or achieving specific texturing qualities by tuning the ASG to accelerate sub-sonic carrier input to supersonic mix of carrier and material thrust velocity modulators using a combinations of nozzles and Compound Parabolic Concentrator Intensifiers whereby the input from a specified spiral is routed into the inlet of a CPCI having a concentration ratio of 3:1 such that the rotation speed rises from 10,000 RPM to about the 500,000 RPMs approximately and is diffused at system output to about 20,000 RPMs approximately. This specific tunability is beneficial for reducing particle to around about 1-5 micron at the top end PSD, and below about 1 Micron at the lower end.

Another example of applicable tunability is having the thickness of additional layers along any portion of the ASG vessel varied to be smaller or larger than the sound wave wavelength, or such layers may include a sealing substrate which is transparent to the sound waves but assist in trapping gasses or liquid between said substrate and the walls of the ASG vessel such that total internal reflections occurs in the ASG vessel.

There is thus provided according to the present disclosure a method for processing a material, comprising propelling a bulk of material, and rotationally impelling the bulk of material, thereby generating acoustic effects operative for processing of the material.

In some embodiments the acoustic effects comprise pressure gradients acoustically coupled to and resonating with the material with a resonance effective for processing the material.

In some embodiments, the method further comprises tuning the resonance by controlling at least one of the acceleration vectors, speed, intensities and velocities of the carrier and modulator flow in motion for effective coupling with the material, thereby obtaining acoustic impedance matching and acoustic absorbance adequate for different materials.

In some embodiments, the method further comprises accelerating the material for intensifying the acoustic effects and may include having the walls of the ASG vessel furnished with specific layer to create an acoustic refractive profiling adequate for inducing total internal reflections (TIR). In some embodiments the vessel walls may be furnished with layers having transparent characteristics for acoustic waves said layers may be smaller than half or quarter of the wavelength of sound generated by the artificial storm in the vessel. In some embodiments of the invention the inner walls of the ASG vessel are furnished with at least one additional layer or substrate which traps air, gas or liquid so as to create adequate refractive index profiling for purpose of inducing acoustic sound waves total internal reflections (TIR). Example of such layers, substrates include the use of plastic, food grade polymers, metals, glass and compounded materials, and the trapping gasses and/or liquids between the layers and the vessels may be air and/or water.

In some embodiments, the method is carried out by a duct-like vessel constructed for rotationally impelling a kinetically introduced material to generate the acoustic effects.

In some embodiments, the vessel is acoustically tunable to fit various materials.

In some embodiments, the material is kinetically introduced into the vessel by way of a fluidic carrier which by interacting with the vessel internal construction generates the acoustic effects.

In some embodiments, the method further comprises:

spiraling a volumetrically measured flow continuum of carrier feed in motion inside a reaction chamber having at least one artificial storm generation conduit or vessel equipped with at least one inlet and outlet for processing flow therewith and after;

catapulting coaxially at least one material modulator which when introduced into the said reaction chamber, is having variable quality and quantity parameters for effecting thrust velocity modulation of said catapulted feed;

inter-spatially delivering mixing and introducing said carrier and modulator to combing, form and effect said feed flow continuum through said vessel modular geometry whereby said geometry is architecturally shaped with at least one functional utilization factor, insert or extension member forming an artificial storm in said vessel;

contouring, tuning, matching, or quantizing the impedance and coupling coefficiencies, altering aspects of said carrier or modulator hydrodynamic or aerodynamic sonic, acoustic, mechanical or kinetic interactive processing interoperability inside said reaction chamber, vessel or conduit;

modulating simultaneously said carrier by said material thrust modulation in said vessel at a predetermined rate speed, acceleration or deceleration, intensity or vector for effecting the compositional, structural or functional quantitative or qualitative properties or proportions of said carrier or modulator or combinations therewith downstream; and

processing said carrier or modulator, or volumetric flow continuum or feed by said artificially generated storm at a predetermined intensity over a predetermine period of time.

In some embodiments, the volumetrically measured flow continuum of carrier feed in motion may include ambient or clean dry air, inert gas, a fluid, a liquid suspension or any combination thereof.

In some embodiments, the volumetrically measured flow continuum of carrier feed in motion contains little or no oxygen.

In some embodiments, the volumetrically measured flow continuum of carrier feed in motion is traveling from about subsonic speed to supersonic speed prior to entry or after exiting the artificial storm generator or any combinations thereof whereby the flow characteristics of said carrier feed in motion may extend from laminar to turbulent flow formats or any combinations thereof.

In some embodiments, the at least one artificial storm generation process produces at least one high power acoustic resonance, wave, waveform or wavefront, standing waves, pressure gradient, or mechanical forced sound vibration having frequency from about 1 Hz to about tens of KHz and wherein the wavelength of the resulting sound waves may extend from about below 1 millimeter to about above several centimeters.

In some embodiments, the at least one artificial storm generation process produces sound waves having a single monophonic pitch, or plurality of such pitches or polyphonic pitched sound waves or combinations thereof. In some embodiments of the invention the sound waves produced by the ASG are subject to total internal reflections.

In some embodiments, the at least one material which when introduced into the said reaction chamber is having variable quality and quantity parameters maybe selected from food and beverage, environmental, agricultural, water, medical, or industrial or petrochemical fields.

In some embodiments, the said material modulator variable quality and quantity parameters may include relative aspects selected from weight, density, mass, temperature, viscosity, hardness, particle size, size distribution, compactness, texture, homogeneity, tactile, taste, smell, aroma or appearance or any combinations thereof.

In some embodiments, the at least one material modulator is effecting the thrust velocity modulation of said catapulted feed by introducing specific mass, volume, momentum and vibrations within the reaction chamber, vessel or conduit of the artificial storm generator.

In some embodiments, the at least one material modulator is introduced at the distal tip of the system exit using the formed artificial storm generation as an atomizer wherein harnessing its acoustic resonance and sound waves effects to create small droplet clouds or spraying patterns wherein droplet size may extend from less than 1 micron to tens or hundreds of microns or combinations such that can be used beneficially for drying processes such as powder drying or concentration of liquid suspension,

In some embodiments, the artificial storm generation process is intensified using at least one modular compound parabolic concentrating intensifier as an insert or geometrically embedded member and wherein the concentration ratio of the Compound Parabolic Concentrating Intensifier (CPCI) may extend from about 2:1 to about 5:1 on its input to output diameter ratios.

In some embodiments, the reaction chamber, or artificial storm generator conduit or vessel are each capable of producing sound waves at wavelength from about 0.5 mm to about 18 cm, at a frequency range from about 0.2 Hz to about 19,999 Hz.

In some embodiments, the frequency range of harmonic generation on any specified fundamental frequency created by the artificial storm generator may extend outside the audio spectrum reaching from about 20,000 Hz to about 70 Khz.

In some embodiments, the artificial storm generator is capable of adjusting, tuning, matching, equalizing and varying the sound producing effects of the system by expanding the volumetric measures of the reaction chamber, conduit or vessel, or by decreasing its dimensions, or by opening or closing extension members or inserts or inputs or outputs or any combinations thereof mechanically operated manually by an operator, or operated semi-automatically or automatically using an operating controller.

In some embodiments, the carrier maybe selected from any propelling gas and whereby the material thrust velocity modulator (TVM) may be selected from food and beverage, chemical, agricultural, medical or pharmaceutical agent constituents or material or any combinations thereof.

In some embodiments, the artificial storm generator can be beneficially implemented safely without any moving parts for purpose of drying, atomizing, homogenizing, concentration, dispersing, coagulating, softening, mixing, smoothing, texturizing, tactility enhancements, for aroma extraction or recovery, for foaming, frosting, coating, cleaning, sterilization, oxidation, crushing, adding, subtraction, compounding and suspension forming processing tasks or any combinations thereof.

In some embodiments, the artificial storm generator increases and enhances coupling efficiencies of acoustic energy or mechanical, hydrodynamic or aerodynamic forces to material modulators and wherein said carrier feed in motion and the sub sequential pressure gradients thus formed by the said artificial storm facilitate a relative increase in the speed of sound.

In some embodiments, the ASG artificial storm generator can be used as an impedance matching workstation whereby increasing or decreasing in the ASG intensities match the acoustic impedance between the sound waves, shock waves, and resonating frequencies and the material modulator and materials to be processed by said ASG.

In some embodiments, the method comprises modulating simultaneously said carrier by said material thrust modulation may include a rotation speed from about 100 RPM to about 1000 RPM at the low speed end, and between about 1001 to about 100,000 at the medium speed end, and from about 101,000 to over 1,000,000 RPM at the high speed end and whereby the transverse speed of the said carrier feed in motion may extend from about subsonic speed below MACH-1, to about hypersonic speed above MACH 5.

In some embodiments, the said artificial storm generated may preempt the need to perform CIP, or special cleaning of inner walls of the said reaction chamber, conduit or vessel due to the high power shearing and tearing forces created by the said processing actions selected from catapulting coaxially, inter-spatially delivering mixing and introducing, contouring, tuning, matching, or quantizing the impedance and coupling coefficiencies, modulating simultaneously said carrier by said material thrust modulation, processing said carrier or modulator, or volumetric flow continuum or feed by said artificially generated storm at a predetermined intensity over a predetermine period of time.

In some embodiments, effecting the compositional, structural or functional quantitative or qualitative properties or proportions of said carrier or modulator or combinations therewith downstream may include enhancing existing produce in the food and beverage, agricultural, medical or pharmaceutical, nutraceutical fields, or creating new innovative products using the method of the present invention.

In some embodiments, the artificial storm generator utilizes retention times from about 10 milliseconds to about 1 second and wherein predetermined intensity, speed and velocity over a predetermine period of time maybe contoured towards achieving the required resonating sound waves from about 1000 Hz to about 19999 Hz monophonically or polyphonically or any combinations thereof.

There is thus provided according to the present disclosure an apparatus for processing a material, comprising a vessel generally formed as a duct having a length and an interior of varying cross-sections along the length, wherein the vessel is formed with a passage for feeding a material thereto and an at least one inlet for providing a carrier thereto for carrying the material father into the vessel and wherein the vessel is constructed with an at least one element for rotationally accelerating the carrier with the material about a longitudinal axis thereof, and wherein the vessel is constructed for inducing an acoustic resonance therein adequate for acoustically processing the material.

In some embodiments, the vessel is constructed to operate as an open resonating column.

In some embodiments, the vessel is constructed to operate as a closed resonating column.

In some embodiments, the acoustic resonance is tunable.

In some embodiments, the at least one inlet is constructed for providing the carrier in a suitable speed for inducing acoustic processing of the material.

In some embodiments, the vessel is further constructed with an at least one nozzle therein for accelerating the carrier to a suitable speed for inducing acoustic processing of the material.

In some embodiments, the apparatus further comprises at least one reaction chamber, conduit or vessel made from biocompatible materials and each having at least one inlet or outlet for introducing a volumetrically measured flow continuum of carrier feed in motion and material modulators to be processed.

In some embodiments, the apparatus comprises said reaction chamber, conduit or vessel accommodating at least one insert, and extension, an intensifying concentrator, a spiral, a concentrator, a LAVAL, a hole, slit or any combinations thereof.

In some embodiments, the length, width, volumetric measures and dimension of the artificial storm generator are chosen to coincide with the wavelength of sound waves which are symmetrical sub-divisions of fundamental frequencies of resonating columns tuned by extending the volume or decreasing the dimensions from about several cubic centimeters to about many hundreds of liters approximately.

In some embodiments, the tuning of resonating wavelength and specific frequencies are effective to accelerate or quench shock waves formation and create a chocked flow regimes or standing waves.

In some embodiments, the reaction chamber, conduit or vessel, insert or inner members within the ASG, may have an identical temperature with ambient temperature, or said temperature may be raised or lowered within the tolerance of the material construction damage thresholds or the material modulator to be processed from about 1-10 Celsius degrees to about several hundred Celsius degrees approximately, or the temperature of the ASG may be lowered below 0 Celsius degrees, or any combinations thereof.

In some embodiments, the carrier gas or fluid maybe accelerated above MACH-1 prior to entering the ASG system architecture, inlet, processing sections or reaction chamber, conduit or vessel.

In some embodiments, the ASG is a resonating atomizer for producing droplet size from about below the 1 micron diameter to about several micron in diameters approximately, which may be beneficial for drying to powder applications.

In some embodiments, the carrier gas or fluid contain little or no Oxygen.

In some embodiments, aroma extraction or addition, recovery or sampling may occur at any stage of processing and can be performed using an external insertion input, output or inner member within the reaction chamber, conduit or vessel.

In some embodiments, the ASG is driven by at least one integrated or external compressor.

In some embodiments, the ASG is driven by at least one industrial blower.

In some embodiments, the pressure of the carrier inlet to the system is between about 0.1 bar to 10 bar approximately and wherein specific high velocity processing may require at least one order of magnitude higher pressures.

In some embodiments, the inner pressure within the ASG architecture may be from about 0.1 bar to about above the 10 bar approximately.

In some embodiments, the exit, output or distal tip of the ASG downstream processing path may include a horn or an acoustic deflector or a guide for increasing the coupling of the acoustic sound waves generated by the artificial storm inside the ASG system to the material modulator which already left the system in a predetermined trajectory angle from about 1 degree to about 180 degrees divergence.

In some embodiments, the ASG is equipped with modular inserts which have inputs or output to the external environment or to additional feeding system for purpose of introducing a plurality of materials to be processed, combined, mixed, homogenized, dried, crushed, textured, or be effected on the physical and compositional levels.

In some embodiments, a serially connected plurality of ASG modules can be used for specific processing task requiring repeatable or cyclic intense processing, while any number of parallel ASG modules maybe operated for producing high throughput from about several milliliters to about 10s or hundreds of cubic meters and whereby 1 duty cycle may extend from about below the 1 second to about above 1 minute or the flow rate of an array of ASG module may have throughput measured per about 1 hour, approximately.

In some embodiments, the storm generated in the ASG is adjusted manually, mechanically, pneumatically or driven by an integrated or external computer for semi-automatic or fully automatic interoperability.

In some embodiments, the temperature, pressure, density and transverse speed of the carrier or material modulator are individually controlled, or uniformly applied, or any combinations thereof.

In some embodiments, the apparatus comprises an ASG architecture designated for drying, crushing, homogenizing, texturizing, altering tactile, smell, aroma, flavor, separating, sorting, phase transferring, atomizing, smoothing, frothing, foaming or any combinations thereof of material modulators selected from food and beverages, agricultural, medical, industrial, environmental, pharmaceuticals, or nutraceutical, or combinations thereof.

In some embodiments of the invention the vessel inner walls are furnished with at least one layer which is transparent to the wavelength of sound. In another embodiments of the invention the walls of the vessel are furnished with a plurality of layers or substrates smaller or larger than the wavelength of sound in order to produce total internal reflections (TIR) in said vessel.

In some embodiments of the invention the total internal reflection is increasing the acoustic energy coupled to materials to be processed both inside the ASG vessel and outside it in proximity to its output.

In some embodiments of the method of the present invention may include the following tunability matrix in which individual tunability aspect maybe tuned for specific processing, or any number of tunable aspects may be tuned such as for example: Processing food and beverage such as coffee or water in liquid or solid form or suspension whereby the resonance is tuned from about 1000 Hz to about over 3000 Hz approximately.

Other embodiments of the invention may include processing materials to be atomized at the ASG output whereby the resonance tuning holes are open for extending the volumetric measure of the ASG and hence lowering the pitch and frequency of the ASG from about 0.2 Hz to about 50 Hz approximately.

Other embodiments of the invention, especially beneficial, at least potentially, for homogenization may include partial opening of the resonance to induce shock waves and standing waves at wavelength from about 1 mm to about several centimeters by elongating the path length telescopically or by adding or subtracting from the length of the ASG system in increments from about 1 milimeters to about several centimeters.

Other embodiments beneficial for processing wide range of materials from fields such as food and beverages, agricultural, medical, environmental and pharmaceutical or nutraceutical whereby any of the tunability aspects are controlled manually or semi-automatically, mechanically or telescopically or by the use of at least one powered moving stage or surface, iris or shutter.

Other embodiments beneficial for processing wide range of materials comprising any or all of the tunability aspect may be controlled by computer using step time, a sequence of tuning action or in a continuous manner, or any combinations thereof.

Other embodiments of the invention include a variable flow rate and duty cycle as a result of tuning one or more of the tunability aspects of the ASG to suit specific processing requirements.

Further is provided according to the present disclosure a method for processing materials by an artificial storm and all devices for use thereof, comprising, spiraling a volumetrically measured flow continuum of carrier feed in motion inside a reaction chamber having at least one artificial storm generation conduit or vessel; catapulting coaxially at least one material modulator which when introduced into the said reaction chamber, is having variable quality and quantity parameters; inter-spatially delivering mixing and introducing said carrier and modulator to combining, form and effect said feed flow continuum; contouring, tuning, matching, or quantizing the impedance and coupling coefficiencies, altering aspects of said carrier or modulator hydrodynamic or aerodynamic sonic, acoustic, mechanical or kinetic processing; modulating simultaneously said carrier by said material thrust modulation in said reaction chamber, conduit or vessel at a predetermined rate speed, acceleration or deceleration, intensity or vector; processing said carrier or modulator, or volumetric flow continuum or feed by said artificially generated storm at a predetermined intensity over a predetermine period of time.

Further, in some embodiments, the method comprises spiraling simultaneously a volumetrically measured flow continuum or feed in motion inside a reaction chamber having at least one artificial storm generation conduit for processing said flowing feed; catapulting coaxially at least one of said material simultaneously having quality and quantity parameters for effecting thrust velocity modulation of said catapulted feed; inter-spatially delivering said carrier and modulator feed through a vessel geometrically architecturally shaped with at least one functional utilization factor, insert or member forming an artificial storm in said vessel by said carrier and modulator flow continuum for effecting the compositional, structural or functional properties of said carrier or modulator therewith downstream; contouring, tuning, adjusting, matching, equalizing, or continually quantizing innocuously the impedance and coupling co efficiencies of said carrier or modulator sonic, acoustic, or kinetic interactive processing interoperability with at least one frequency, wave or resonating ripple down and/or upstream; modulating simultaneously said carrier by said material thrust modulation in said vessel at a predetermined rate speed, acceleration or deceleration, intensity or vector; and processing said carrier or modulator, or flow continuum or feed by said storm at a predetermined intensity over a predetermine period of time.

In some embodiments, the conduit is formed with any number of cavities downstream from the first spiral thereby further downstream accelerating the carrier fluid.

In some embodiments, the material and carrier are propelled forward through a serially connected or interfaced cavities each having a predetermined cross-section, gap or diameter so as to create variable pressure gradients or to produce acoustic streaming or resonating effects.

In some embodiments, the material and carrier are propelled forward until reaching the output of the system wherein through the output the sonic or pressure gradients, or spatial flow shaping occurs for purpose of beneficially creating small droplets for further processing for example such as for spray drying or freeze drying.

In some embodiments, an at least another inlet is constructed in a wall of the third cavity and obliquely directed to the second spiral for introducing a carrier fluid into the third cavity in at least a supersonic speed, thereby the material is further sucked into the third cavity and impinged on the second spiral so that the carrier fluid and the material are further accelerated both longitudinally downstream and rotatively and compressed and concentrated towards the wall of the third cavity thus at least physically further processing the material.

In some embodiments, the at least a supersonic speed is hypersonic speed.

In some embodiments, at least physically processing the material comprises compositionally processing the material.

In some embodiments, the second spiral is of a constant pitch.

In some embodiments, the conduit is constructed to induce an acoustic resonance.

In some embodiments, the acoustic resonance comprises standing acoustic waves.

In some embodiments, the resonance is of an open or closed column types, or of a vibrational resonance type or combinations thereof.

In some embodiments, the vessel is constructed to facilitate control of the acoustic resonance by increasing, or decreasing the volumetric measure of the processing chamber and artificial storm generator conduit. Such adjustments may also be effectively implemented using an intrusive members or extension tips.

In some embodiments, the vessel is constructed to facilitate control of the acoustic resonance by an at least one hole or extension. In a mode of operation according to some embodiments, such extension tips, inserts or members may be introduced into the processing chamber manually, semi-automatically, or automatically via moving stage, a swiveling screw or via a mechanical or electronic moving parts.

In some embodiments, the vessel comprises a reservoir upstream from the first end for providing the material. In a group of embodiments, the ASG may be formed form biocompatible materials such as stainless steel or compounded polymers and its exemplary mode of operation may include rotation speeds in excess of 600,000 RPM, in a group of embodiments the preferred rotational speed maybe accelerated to several Million RPM such that supersonic and hypersonic speeds are achieved.

In some embodiments, using total internal reflections for sound waves is wherein the critical angle is about 14 degrees and wherein additional layers are furnished along at least one portion of the inner walls of the ASG vessel said layers maybe thinner than half or quarter of the sound wavelength and wherein said layer may include a rough surface protrusions or curvature extending to about 1 mm to about 1 cm approximately. At least one of said additional layers may be furnished such that it traps air or gas between the layer and the inner walls of the ASG vessel. Another layer may be trapping liquid or water as to create a medium in which sound waves propagate faster or slower within the ASG vessel.

In some embodiments, a mode of operation may include processing food and beverage componential constituents for purpose of homogenization at acceleration starting point of 1500 RPM and processing at 8000 RPM, certain crushing effects may be best achieved at about 1000000 RPM.

Some embodiments for food and beverage, agriculture, medical or pharmaceutical fields may include pre-boosting the speed of a propelling carrier gas or fluid prior to entry to the ASG (Artificial Storm Generator), this allows for quick acceleration and shortening of kick-starting processing to a fraction of a second in regions from about 0.01 second to about 1.1 second approximately.

In some other embodiments, the actual acceleration may occur inside the ASG by the interspatial shaping of its inner architecture. More specifically, in some embodiments, this may be achieved by integrating a LAVAL shape acceleration sections, or by the use of modular inserts such as a CPCI (Abbreviated term) Compound Parabolic Concentrating Intensifier having concentration ratio between their inlet diameter to their outlet diameter of between about 1.2:1 to above about 8:1 approximately-depending on the required acceleration and processing requirements obviously within the limit for compressibility and structural safety.

Some embodiments include using the artificial storm generator as a tunable atomizer for further processing such as drying or concentration processes. A mode of operation for such atomizing may include creating an open column resonance at between about 1000 Hz to about 3000 Hz, while for certain materials to be processed a higher resonance of between about 1001 Hz to about 19999 Hz is more suitable.

In some embodiments, the vessel comprises a collector downstream from second cavity for collecting the processed material.

In some embodiments, the material is pumped into the ASG, in other the material is compressed into the ASG using a pressurized carrier feed or pneumatic pressure feed.

In some embodiments, the carrier temperature and viscosities are changed lowered or increased prior, during or after entry into the ASG processing platform. In some embodiments the material is processed to be atomized, or fogged on output from the ASG for further drying or processing, or for collection.

In some embodiments, the entire ASG apparatus is an acoustic amplifier or resonator for effecting target sites outside the processing architecture such that in atomization, fogging, or in effecting droplets or particles in proximity to said ASG distal end or output.

ASG method and devices do not require high pressure, e.g. 100 bars, and hence it is safer to use, reduced in size and can be utilized without difficulty. ASG can be used, for example, with pressure of 0.2-2 bars. Furthermore, there are no moving parts inside the ASG device hence greatly enhancing safety.

ASG method and devices allow tuning the acoustic waves and ripples such that wide variety of materials can be processed by tuning the acoustic waves to the resonance range and specific resonance of specific materials.

ASG method and devices is not confined to separating droplets from gas; rather, it can process a vast range of solids, suspensions, mixtures and combinations.

ASG method and devices allow using any materials to be processed as a Thrust Velocity Modulation by interacting with the carrier gas or fluid.

ASG method and devices may be used for processes such as atomization, homogenization, mixing, recombination, extraction, drying, texturing, frothing, foaming, smoothing, tactile adjustment, and more.

ASG method and devices allow for adding additional materials throughout the processing stages so as to create new and innovative products, not only processing existing products.

ASG method and devices is able to produce various pitches and acoustic sound waves simultaneously (i.e. polyphonic) hence greatly increasing the efficiencies of the processing achieved by sound waves with or without the use of total internal reflections (TIR).

ASG method and devices is modular, wherein the actual geometry of the ASG can be easily and intuitively altered to cater for the need to process various materials using the modular inserts such as CPCI (Compound Parabolic Concentrating Intensifiers, Spirals of variable and set pitch gateways and I/O).

ASG method and devices can use either pre-accelerated supersonic driving carrier gas or fluids, as well as accelerate the carrier and Thrust Material Modulator within the actual ASG geometry itself.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

When a range of values is recited, it is merely for convenience or brevity and includes all the possible sub-ranges as well as individual numerical values within and about the boundary of that range. For example, whenever a specific acoustic resonance or frequency or waveform is quoted, that also include its harmonic generation and subsequent waves, frequency range, resonance and waveforms thus formed or can be produced.

Any numeric value, unless otherwise specified, includes also practical close values enabling an embodiment or a method, and integral values do not exclude fractional values. A sub-range values and practical close values should be considered as specifically disclosed values.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

1-58. (canceled)

59. An apparatus for processing a material, comprising:
a vessel generally formed as a duct having a length and an interior of varying cross-sections along the length, wherein:
the vessel is formed with a passage for feeding a material thereto and an at least one inlet for providing a carrier thereto for carrying the material farther into the vessel;
the vessel is constructed with an at least one element for rotationally accelerating the carrier with the material about a longitudinal or cross section axis thereof; and
the vessel is constructed for inducing an acoustic resonance therein adequate for acoustically processing the material.

60. The apparatus according to claim 59, wherein the vessel is constructed to operate as an open resonating column.

61. The apparatus according to claim 59, wherein the vessel is constructed to operate as a closed resonating column.

62. The apparatus according to claim 59, wherein the acoustic resonance is tunable.

63. The apparatus according to claim 59, wherein the at least one inlet is constructed for providing the carrier in a suitable speed for inducing acoustic processing of the material.

64. The apparatus according to claim 59, wherein the vessel is further constructed with an at least one nozzle therein for accelerating the carrier to a suitable speed for inducing acoustic processing of the material.

65. The apparatus according to claim 59, further comprising:
at least one reaction chamber, conduit or vessel made from biocompatible materials and each having at least one inlet or outlet for introducing said carrier and material modulators to be processed.

66. The apparatus according to claim 65, wherein the tuning of resonating acoustic wavelength and specific frequencies are effective to accelerate or quench shock waves formation and to create a chocked flow regimes or standing waves.

67. The apparatus according to claim 65, wherein the pressure of the carrier inlet to the system is between about 0.1 bar to 10 bar and wherein specific high velocity processing may require pressure that is at least one order of magnitude higher than said pressure of said carrier inlet.

68. The apparatus according claim 65, wherein the inner pressure within the vessel is from about 0.1 bar to about 10 bar or higher.

69. The apparatus according to claim 65, wherein the exit, output or distal tip of the vessel downstream processing path comprise a horn or an acoustic deflector or a guide for increasing the coupling of the acoustic sound waves generated inside the vessel to the material modulator which already left the system in a predetermined trajectory angle from about 1 degree to about 180 degrees divergence.

70. The apparatus according to claim 59, wherein at least one portion of the inner walls of the vessel are constructed with rough surface protrusions or curvature and whereby at least two additional layers or substrate selected from solid, liquid, or gas interface are attached to inner walls for forming a refractive index profiling for inducing total internal reflection of acoustic waves in the vessel.

71. The apparatus according to claim 59, wherein the walls of the vessel are furnished with a plurality of layers transparent to the acoustic waves or thinner than approximately half or quarter wavelength.

72. A method of processing a material, comprising:
spiraling a carrier feed inside a reaction chamber having an artificial storm generation vessel forming an artificial storm therein;
catapulting a material modulator coaxially with said carrier feed for effecting thrust velocity modulation of said carrier feed; and
processing said carrier feed or said material modulator by said artificially generated storm at a predetermined intensity over a predetermine period of time.

73. The method according to claim 72, wherein said carrier feed comprises at least one of ambient dry air, clean dry air, inert gas, a fluid, a liquid suspension and any combination thereof.

74. The method according to claim 72, said wherein said carrier feed is devoid of oxygen.

75. The method according to claim 72, wherein said carrier feed is traveling from about subsonic speed to supersonic speed prior to entry or after exiting the artificial storm generator.

76. The method according to claim 72, wherein said material modulator comprises at least one of: food, beverage, environmental material, agricultural material, water, medical material, industrial material and petrochemical material.

77. The method according to claim 72, wherein said artificial storm acts as an atomizer creating droplet clouds or spraying patterns of said material modulator, wherein a droplet size is from less than 1 micron to tens or hundreds of microns, for use in drying processes such as powder drying or concentration of liquid suspension.

78. The method according to claim 72, wherein said artificial storm is intensified using a modular compound parabolic concentrating intensifier as an insert or geometrically embedded member, and wherein the concentration ratio of the Compound Parabolic Concentrating Intensifier (CPCI) is from about 2:1 to about 5:1 on its input to output diameter ratios.

79. The method according to claim 72, wherein said carrier feed comprises at least one of food, beverage, chemical material, agricultural material, medical material, pharmaceutical agent, and any combinations thereof.

80. The method according to claim 72, comprising using a serially connected plurality of artificial storm generation vessels in a manner that an output of one vessel is fed to an inlet of another vessel.
